(19) United States
(12) Patent Application Publication
(10) Pub. No.: US 2016/0156652 A1
(43) Pub. Date: Jun. 2, 2016

(54) PATTERN DETECTION IN SENSOR NETWORKS

(71) Applicants: RANDY PAFFENROTH, Loveland, CO (US); Philip Du Toit, Berthoud, CO (US); Louis Scharf, Fort Collins, CO (US)

(72) Inventors: RANDY PAFFENROTH, Loveland, CO (US); Philip Du Toit, Berthoud, CO (US); Louis Scharf, Fort Collins, CO (US)

(73) Assignee: Numerica Corporaition, Loveland, CO (US)

(21) Appl. No.: 13/564,335

(22) Filed: Aug. 1, 2012

Related U.S. Application Data
(63) Continuation-in-part of application No. 13/452,480, filed on Apr. 20, 2012.

(51) Int. Cl. H04L 29/06

(52) U.S. Cl. CPC H04L 63/1425

(57) ABSTRACT

A method of detecting an anomaly in a sensor network for diagnosing a network attack may include receiving a data set comprising a plurality of vector-valued measurements from a plurality of sensors, and decomposing the data set into a low-rank component L and a sparse component S using an Augmented Lagrange Multiplier (ALM) method. In one embodiment, at least one of L or S can be determined using an exact minimizer of a Lagrangian in the ALM method, L can represent patterns that occur in a relatively large number of the plurality of sensors, and S can represent patterns that occur in a relatively small number of the plurality of sensors. The method may also include ascertaining, using the computer system, the anomaly in the data set based on the patterns in the sparse component S.

### CROSS-REFERENCES TO RELATED APPLICATIONS

The present application is a continuation-in-part and claims the benefit of U.S. patent application Ser. No. 13/452,480, filed Apr. 20, 2012 by Paffenroth et al. and entitled “Pattern Detection in Sensor Networks,” of which the entire disclosure is incorporated herein by reference for all purposes.

### STATEMENT AS TO RIGHTS TO INVENTIONS MADE UNDER FEDERALLY SPONSORED RESEARCH AND DEVELOPMENT

This invention was made with government support under contract FA9550-10-C-0090 (STTR Phase I) and FA9550-12-C-0023 (STTR Phase II) awarded by the United States Air Force Office of Scientific Research. The government has certain rights in the invention.

### BACKGROUND OF THE INVENTION

Real-time automated detection of anomalies in large volumes of heterogeneous data can allow Network Operation Centers (NOCs) to identify the most important patterns that warrant attention, thereby affording more informed and efficient decision-making Unfortunately, there are many challenges that limit the application of standard approaches for automated anomaly detection. Textbooks and an extensive set of literature contain many approaches and algorithms for “data mining” and “machine learning”, but standard algorithms for “supervised learning” require large amounts of labeled training data, predefined models, or expert knowledge before anomalous behavior can be detected. These approaches make the assumption that nominal behavior, anomalous behavior, or even both have been identified a priori for the given context.

In the most common case, anomolies are defined a priori as known patterns that are expected to appear in a data set. Identifying anomolies in a data set then becomes an exercise in determining whether or not any patterns in a listing of known patterns occurs one or more times in the data set. In most cases, this process comprises a search through the data set to identify known signatures, or markers, that indicate the presence of a known pattern. This process may also be referred to as “template matching”, “pattern recognition”, or “signature identification”. While pattern matching may be sufficient for detecting known anomalies, it is inadequate for detecting unknown and/or new anomalies. Therefore, improvements are needed in the art.

### BRIEF SUMMARY OF THE INVENTION

The methods and systems described herein may include specific embodiments that may be implemented in a computer system that is communicatively coupled to a heterogeneous sensor network. Accordingly, a method of detecting an anomaly in a sensor network for diagnosing a network attack may include receiving a data set comprising a plurality of vector-valued measurements from a plurality of sensors, and decomposing the data set into a low-rank component L and a sparse component S using an Augmented Lagrange Multiplier (ALM) method. In one embodiment, at least one of L or S can be determined using an exact minimizer of a Lagrangian in the ALM method, L can represent patterns that occur in a relatively large number of the plurality of sensors, and S can represent patterns that occur in a relatively small number of the plurality of sensors. The method may also include ascertaining, using the computer system, the anomaly in the data set based on the patterns in the sparse component S.

The method may further include transforming the data set into its normalized correlation matrix defined by the product of the data set and a transpose of the data set, wherein the transformation is done prior to decomposing the data set. The method may also include determining the anomaly in the normalized correlation matrix based on the patterns in the sparse data set S; and determining whether the anomaly represents unrecognized activity by analyzing the data set using at least the anomaly in the normalized correlation matrix. The method may additionally include decomposing the data set into a third component E that is approximately diagonal representing phenomena uncorrelated with any other sensors. The method may also include determining that S is sparse if the number of entries in S that are less than a predetermined tolerance is less than a threshold proportional to the number of the plurality of sensors multiplied by the number of vector-valued measurements. The method may additionally include determining that L is low rank if the number of singular values of L that are greater than a predetermined tolerance is less than a threshold proportional to the number of the plurality of sensors.

In one embodiment, the data set may be represented in a memory as a matrix constructed by concatenating the plurality of vector-valued measurements, wherein each line in the matrix represents the plurality of vector-valued measurements from one of the plurality of sensors. In another embodiment, one or more of the plurality of sensors may be heterogeneous, such that an error tolerance assigned to each of the plurality of sensors is not uniform. In yet another embodiment, the phenomena uncorrelated with any other sensors may represent uncorrelated noise. In yet another embodiment, decomposing the data set may comprise minimizing ∥L∥_{*}+λ∥S∥₁ with respect to L and S subject to a constraint that |P_{Ω}(M−L−S)| [symbol] ε, wherein P comprises a projection operator, M comprises a subset of the pair-wise similarities of the plurality of sensors, Ω comprises designations of the entries in M that are used, λ comprises a scalar weighting factor, and E comprises a representation of error tolerances stored in a memory.

In another embodiment, a system is presented. The system may comprise one or more processors and a memory communicatively coupled with and readable by the one or more processors and having stored therein a sequence of instructions which, when executed by the one or more processors, cause the one or more processors to determine whether an anomaly exists in a data set Y collected from heterogeneous sensor data by receiving the data set Y, wherein Y is m by n, m represents a number of data sources providing the heterogeneous sensor data, and n represents a number of measurements received from each of the number of data sources; deriving a second-order data set M from Y, wherein M represents a subset of the pair-wise similarities of the data sources; decomposing matrix M into at least a first component L and a second component S; ascertaining an anomaly from when L is low rank and S is sparse; and sending an indication of a subset of the data sources that produced the anomaly based on a location of the anomaly in S.

The instruction may further cause the one or more processors to determine whether an anomaly exists in a data set Y by determining a location of the anomaly in the data set M; and determining whether the anomaly represents malicious intent by analyzing the data set Y using the location of the anomaly in the data set M. The instruction may also cause the one or more processors to determine whether an anomaly exists in a data set Y by using an Augmented Lagrange Multiplier (ALM) method to decompose the data set M. In one embodiment, the data set M comprises a correlation between a subset of the data sources based on physical communication pathways between the data sources. In another embodiment, decomposing the data set M comprises minimizing ∥L∥_{*}+λ∥(S_{ε}(S)∥₁ with respect to L and S subject to the constraint that P_{Ω}(M−L−S)=0, wherein P comprises a projection operator, Ω comprises designations of the entries in M that are used, λ comprises a scalar weighting factor, and ε comprises a representation of error tolerances stored in a memory.

In yet another embodiment, a computer-readable memory is presented, having stored thereon a sequence of instructions which, when executed by one or more processors, causes the one or more processors to detect an anomaly in a matrix Y of sensor data by deriving a second-order matrix M from Y, wherein M=YY^{T;} receiving a constraint matrix ε comprised of error tolerances for the sensor data; determining a low-rank component L of M using singular value shrinkage; determining a sparse component S of M using matrix shrinkage and leeway in the constraint matrix ε; and determining a location of the anomaly in Y based on a set of off-diagonal entries in S.

In one embodiment, L and S are determined by minimizing a Lagrangian function of L and S using an ALM method. In another embodiment, each iteration of the ALM updates the value of L according to L=D_{μ}_{^{−1}}(M−S+μ⁻¹Z), wherein με [symbol] , and μ is proportional to ∥M∥₂, Z comprises a value proportional to

$$\frac{M}{{‖ M ‖}_{2}} ,$$

and D comprises a singular value shrinkage operator. In yet another embodiment, each iteration of the ALM updates the value of S by determining a minimum value of a sum of an absolute value cone, a linear shrinkage operator, and a quadratic shrinkage operator. In yet another embodiment, determining a low-rank component L of M further comprises using leeway in the constraint matrix ε. In yet another embodiment, the sum is further divided into one or more groupings of terms, each of the groupings of terms depending on only a single value in S, and each of the groupings of terms being minimized independently.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1A illustrates a representation of a sensor network modeled as a graph, according to one embodiment.

FIG. 1B illustrates a representation of a set of measured signals from a network, according to one embodiment.

FIG. 2 illustrates a data set, or matrix, that can be constructed from the vector-valued time series of a plurality of nodes, according to one embodiment.

FIG. 3 illustrates a representation of a latent signal model, according to one embodiment.

FIG. 4 illustrates an example of recovering a sparse matrix using specific values, according to one embodiment.

FIG. 5 illustrates the results of series of Monte Carlo tests using random matrices, according to one embodiment.

FIG. 6 illustrates a map showing the geographical location of the nodes that participated in the Abilene network, according to one embodiment.

FIG. 7A illustrates an example of the sparse matrix from a time period before a pattern has been injected, according to one embodiment.

FIG. 7B illustrates an example of a sparse matrix with an anomaly, according to one embodiment.

FIG. 7C illustrates a cross validation of anomalies, according to one embodiment.

FIG. 8A illustrates an example of a pattern detected from raw Abilene data, according to one embodiment.

FIG. 8B illustrates the corresponding time series that illustrates a detected Abilene anomaly, according to one embodiment.

FIG. 9 illustrates a block diagram illustrating components of an exemplary operating environment in which various embodiments of the present invention may be implemented, according to one embodiment.

FIG. 10 illustrates a block diagram illustrating an exemplary computer system in which embodiments of the present invention may be implemented, according to one embodiment.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Presented herein is a mathematical and computational framework for detecting and classifying weak distributed patterns in sensor networks. Embodiments discussed herein demonstrate the effectiveness of space-time inference on graphs, robust matrix completion, and second order analysis in the detection of distributed patterns that are not discernible at the level of individual nodes. The resulting capabilities may be applicable to many types of sensor networks including but not limited to: computer networks, databases, wireless networks, mobile sensor networks, social networks, and disease outbreaks. Motivated by the importance of the problem, some embodiments may be particularly directed towards detecting weak patterns in computer networks in a field known as “Cyber Situational Awareness”. Specifically of interest are scenarios where a set of computer nodes (terminals, routers, servers, etc.) act as sensors that provide measurements, such as packet rates, user activity, central processing unit usage, etc., that, when viewed independently, cannot provide a definitive determination of any underlying pattern. However, when these individual data are fused with data from across the network both spatially and temporally, relevant patterns may emerge. Therefore, detectors and classifiers that use a rigorous mathematical analysis of temporal measurements at many spatially-distributed points in the network can identify network attacks or other such anomalies.

Traditional methods, such as pattern matching, require large amounts of labeled training data, predefined models, or expert knowledge before anomalous behavior can be detected. In short, a priori information about the anomalies was required. These approaches necessarily make assumptions about what constitutes nominal behavior and anomalous behavior a priori for each given context. In contrast, embodiments discussed herein use an “unsupervised learning” approach that employs techniques for robust matrix completion and compressed sensing. These embodiments provide a mathematical and computational framework for detecting and classifying weak, distributed anomalies in data produced by an array of heterogeneous sensor modalities. Specifically, embodiments may use robust matrix completion and anomaly analysis to detect distributed non-conforming data that is not discernible at the level of individual sensors.

In contrast to methods that are context dependent, such as pattern matching, these embodiments do not need to make a value judgment, such as “this is an attack” or “this is not an attack.” Instead, what is provided is an efficient way to process large volumes of data, and focus attention where it is most needed. In one embodiment, the computational core of the analysis can be phrased as a convex optimization problem that can be solved efficiently and in real-time on large datasets. In addition, this analysis can detect anomalies even when the data of interest is distributed across multiple databases, and is too large or too unwieldy to aggregate in a centralized location for processing. Lastly, these methods can effectively address the uncertainty inherent in real-world measurements.

The methods and systems presented herein may also be contrasted with a field known in the art as “unsupervised learning”. Unlike pattern matching, unsupervised algorithms may have the property that they do not require templates. However, the embodiments presented herein differ in a number of ways, such as the use of second-order analysis. Perhaps more importantly, the embodiments herein have been designed to deal effectively with uncertainty that is unavoidable in sensor data. It is these properties that make these embodiments applicable to real world problems.

As used herein, the term “pattern” will be understood as a broad and inclusive term. In some cases, the term pattern may be used to describe an “anomaly”. An anomaly may be defined in a context-independent manner as an abnormal or unexpected spatio-temporal dependence in a data set collected across a plurality of sensors. Note that this does not require a data sequence to match some type of a priori template to be considered an anomaly. Instead, the embodiments herein may use methods that allow an anomaly to reveal itself in the data by way of dependence or independence between observed sequences of measurements from each sensor. This definition of normal and anomalous is based upon mathematical notions of low-rank and sparsity. In particular, these methods discover anomalous behavior that is characterized by correlations shared by only a sparse subset of the sensors that do not conform to a low-rank background correlation.

Previous solutions focused on detecting anomalies that were enumerated a priori in a catalog, or described by a set of well-known markers or signatures. That type of scenario often reduced to a straightforward search problem. In contrast, embodiments herein are directed towards the more subtle problem of uncovering anomalies that are not specified at the outset. This allows for an “I don't know what I'm looking for, but I'll know it when I see it” approach. Detection of anomalies does not in and of itself constitute detection of threats or attacks, i.e. anomalies do not necessarily imply malicious behavior. Detecting anomalies does not require assigning a value judgment to data dependencies in order to determine whether actors are bad, nor does it require a long list of semantic rules for identifying malicious intent. Rather, these methods sift through large amounts of raw data in order to identify unusual anomalies of behavior that are out of step with the norm, where the definition of “normal” and “anomalous” arises naturally from the data, and is not externally imposed. Following this approach, the result may be simply the detection of unusual correlated activity on a set of nodes. This may lead to further examination of the nodes to ensure that they have not been compromised.

This disclosure assumes that the reader is familiar with recent advances in compressed sensing, matrix completion, robust principal component analysis, and simple model discovery to provide a mathematical foundation for anomaly detection. Embodiments discussed herein couple the unique definition of a distributed anomaly introduced above with the recovery of low-rank and sparse representations of data from surprisingly few measurements to analyze heterogeneous sensor networks. Furthermore, some embodiments extend decomposing the data into low-rank and sparse constituents to include noisy data. A formulation is introduced that allows for point-wise inequality constraints, which in turn allows for de-noising of data sets subject to specified noise thresholds. The methods and systems presented herein for pattern detection also apply to scenarios in which the relevant data is only partially observed. Consequently, these methods are well-suited for computation on a network where transmission of all the raw data may be infeasible. Pattern detection thus becomes possible without requiring transmission of any time series between the nodes.

The mathematical framework and methods developed herein are applicable to very general classes of sensor networks. Some embodiments focus on computer networks as a key motivating application area; however, there are no assumptions or heuristic arguments that are specific to computer networks. Hence, the mathematical principles are immediately transferable to all applications of sensor networks and other similar applications.

### Data Representation

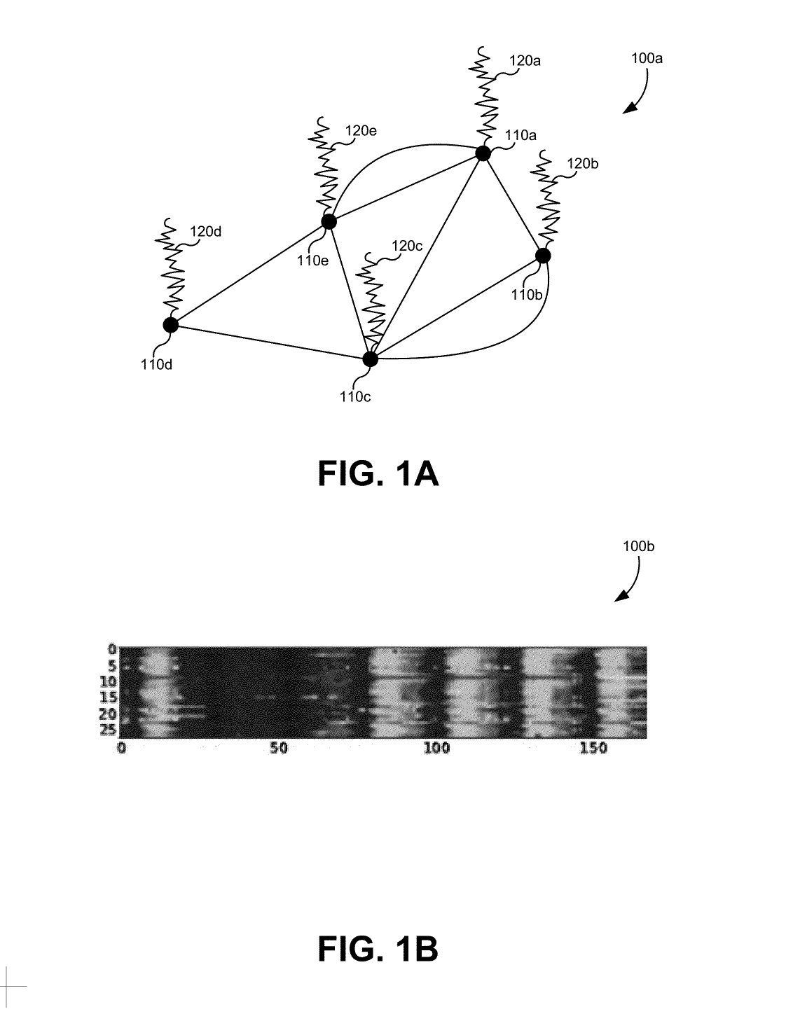

First, it may be helpful to lay out a methodology for representing sensor data that may be used as an input for pattern detection. Initially, another key term should be defined along with a “pattern”, namely a “network”. A sensor network may be defined as a graph, each of whose nodes is a sensor measuring a (real) vector-valued time series. FIG. 1A illustrates a representation of a sensor network 100a modeled as a graph. The nodes 110 may represent sensors of any variety, each with a time series 120 of measurements. In embodiments related to information assurance on a computer network, the measured time series might represent port activity, CPU load, packet rates, password failures, etc. Generally, each node 110 may measure some time series 120 of interest. In many cases, no individual node 110a would have enough information to detect anomalies; however, distributed patterns may be observed across a plurality of the nodes 110. FIG. 1B illustrates a representation 110b of a set of measured signals from a network. The image suggests the presence of one or more network-wide patterns. The oscillatory nature of the packet activity may indicate circadian dependence with preference for diurnal activity (excluding weekends). Specifically, the period of high packet rate on the left followed by two periods of low packet rate and four more periods of high packet rate may correspond to the daily ebb and flow of Internet traffic. The two periods of low packet rates may correspond to Saturday and Sunday traffic.

It should be noted that many of the examples and embodiments described herein may refer to the measurements from a plurality of sensors as a “time-series” measurement. This designation may refer to measurements taken from a single sensor at successive time intervals. In addition to time-series measurements, some embodiments herein may refer to a broader term, namely “vector-valued” measurements. A time-series measurement may be considered a subclass of vector-valued measurements. Vector-valued measurements may include any characteristics of a particular sensor, such as a time a measurement was taken, a sensor classification, a customer, a location, and/or the like. Each of the examples and embodiments described herein may use either time-series measurements or vector-valued measurements interchangeably.

The data from the sensor network in FIG. 1A may be represented mathematically as a set of vectors. More precisely, the network 100a may be represented as a graph G={E, V} with a set of edges, E, and a set of vertices, V. Each vertex vᵢεV may be assigned a discrete vector-valued time series yᵢε [symbol] ^{l}^{_{i×n}}. Thus, each sensor at vᵢ collects a vector-valued measurement of dimension lᵢ and duration n. From this, a signal matrix Y ε [symbol] ^{m×n} may be constructed by concatenating all the vector-valued time series from one or more of the nodes.

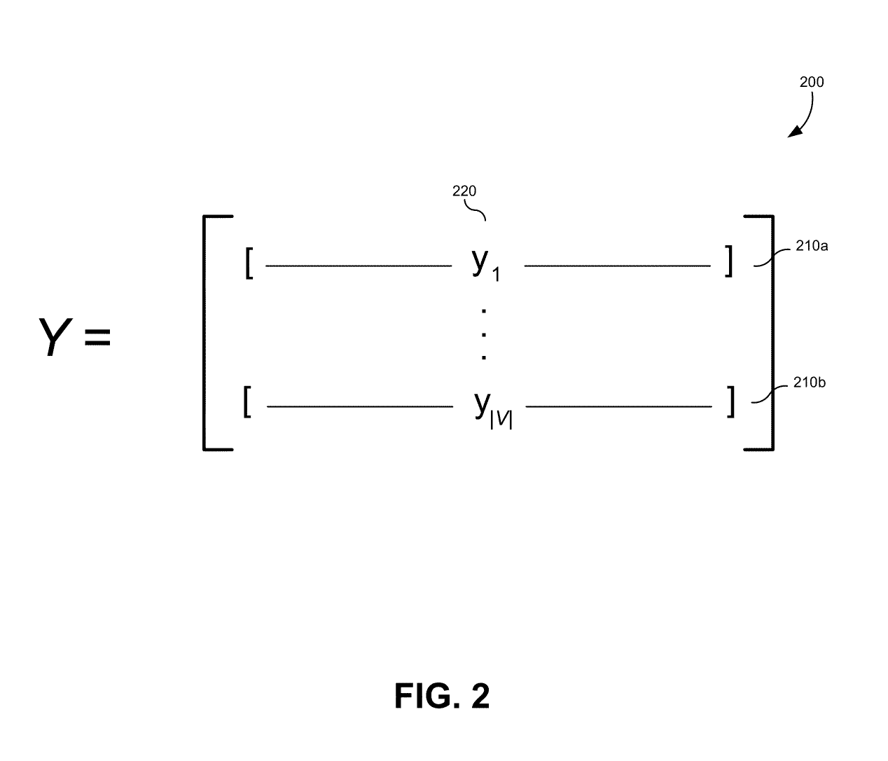

FIG. 2 illustrates a data set, or matrix 200, that can be constructed from the vector-valued time series of a plurality of nodes. In this embodiment, each row 210 in the matrix 200 may represent a set of measurements taken from a sensor. Consequently, each column 220 may represent the measurements taken from the plurality of sensors at a specific moment in time. The number of rows in Y is m=Σᵢ₌₁^{|V|}lᵢ, and the number of columns in Y is the number of discrete time intervals for which data was collected. The matrix Y therefore may have rows 210 that are time traces of a particular quantity of interest (the CPU load of node i, for example), and may have columns 220 which provide a spatial snapshot of the state of the network at a particular time. For example, the representation 100b of a set of measured signals in FIG. 1B may contain packet load measurements for one week across each link in a computer network. Note that in some embodiments, the times in each of the columns 220 may be approximate, such that the actual time that each measurement in a column is taken may be within an error window of a target time.

Having defined the “network” above, a first step in recognizing a “pattern” may be to again emphasize an approach that is not taken. According to one embodiment, the goal may not be to perform a priori “template matching”, “pattern recognition”, or “signature identification”. While scanning packets to perform a priori signature matching is a useful method for virus checking, detecting worms and malware, etc.; these embodiments utilize an approach that relies on detecting abnormal conditions occurring in the network via measurable network attributes represented by the time series correlations. During a distributed attack, the time series at any given link or node may not be suspicious or unusual, but when examined in the context of multiple links with respect to current and past network conditions, the attack may appear as a discernible anomaly.

Consequently, statistical techniques for weak distributed pattern detection may be used for detecting and characterizing distributed anomalous conditions in challenging real-world scenarios. Even though the detection of an anomalous condition may not indicate the presence of a malicious threat, it can still be a useful tool in developing a response strategy for attacks, especially when fused with data from other sensors. Detection of abnormal conditions may be used to invoke trigger mechanisms and initiate counter measures to mitigate potential attacks. At a minimum, the detection of anomalous conditions can trigger network management responses to better diagnose the network and meet quality of service targets. Fast identification of geographically distributed links and nodes related to the same abnormal condition can lead to more focused and effective counter-measures against distributed attacks.

Returning to signal matrix Y, some embodiments may assume that Y obeys a latent time series model. In this approach, the key modeling principle is that the rows of Y are in fact linear combinations of underlying fundamental processes that are uncorrelated (or nearly uncorrelated). In particular, it may be assumed that the raw data matrix is composed as follows:

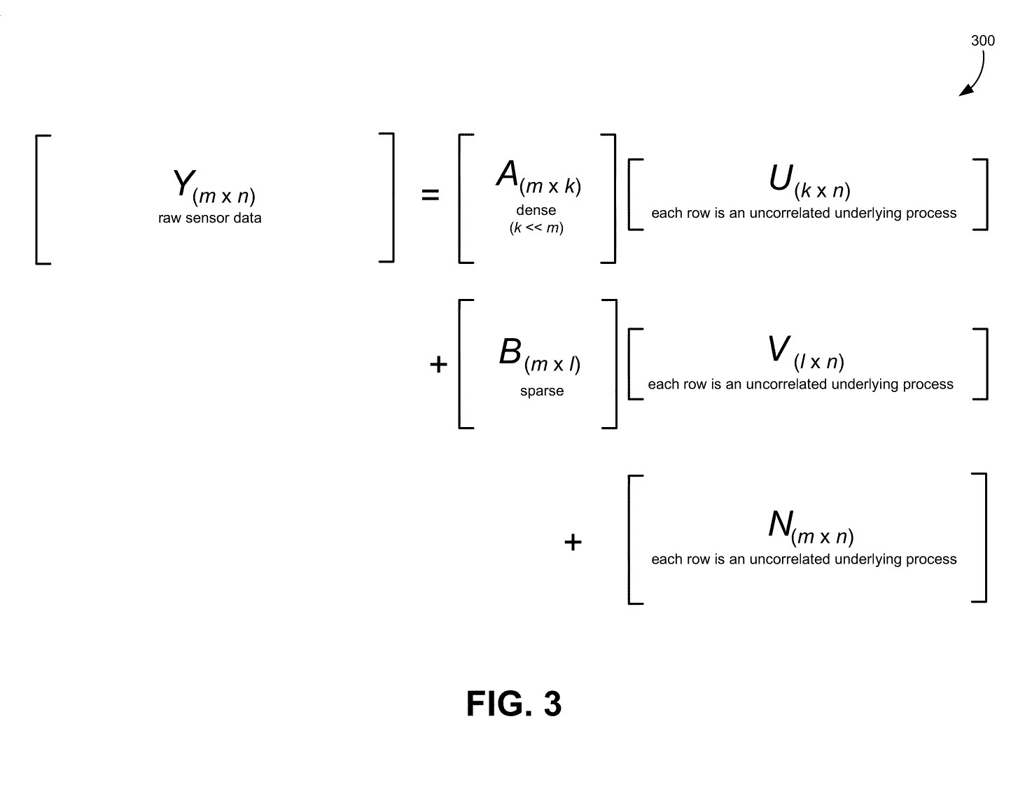

Y=AU+BV+N, (1)

where AΣ [symbol] ^{m×k} is dense but low-rank, Bε [symbol] ^{m×l} is sparse, and the matrices Uε [symbol] ^{k×n}, Vε [symbol] ^{l×n}, and Nε [symbol] ^{m×n} have mutually orthogonal rows. The structure of the model is perhaps best communicated by considering the shapes and properties of the various matrices involved. FIG. 3 illustrates a representation 300 of the latent signal model used for the matrix Y.

It may be of interest to note that a matrix may be considered to be low rank in at least two different ways. First, a matrix can be low-rank because its columns are linearly dependent on only a few independent vectors. Second, even if all the columns are linearly independent (so that the matrix is “full-rank”) the shape of the matrix may prohibit it from having a large rank. A matrix with only a few columns cannot have rank larger than the number of columns. In some embodiments herein, it is expected that k<m. For an m×k matrix, with k<m, the largest rank that the matrix can possibly have is k. Consequently, when A is described above as being “low-rank”, it is because A has the property that k<<m. Therefore, the resulting matrix AU, which is of size m×n, will necessarily be low rank because it has rank of at most k, and k<<n and k<<m.

The idea of this decomposition is to write Y as a linear combination of mutually uncorrelated time traces that represent the core contributing sources to any particular measured time series. The spirit of the approach is to simultaneously determine those nodes whose behavior is well-explained by the behavior of all their peers, as well as those nodes that appear to be affected by an unusual underlying process that is outside the mainstream. Therefore, the latent time series model may be comprised of the following structure:
AU: Since A is dense, a trace in AU may be a linear combination of all the underlying processes in U. Thus, U contains the (few) uncorrelated underlying processes that affect all the nodes in the graph G. The ebb and flow of diurnal activity that affects all nodes is an example of such a process. Since rows in AU are linear combinations of only a few underlying processes, the matrix AU is necessarily low-rank.
BV: Since B is sparse, a row in BV representing a time-series trace is a linear combination of only a few (perhaps only one, or two, or even none) of the underlying processes V. Thus, V contains the uncorrelated underlying processes that simultaneously affect only a sparse part of the graph G.
N: N models the underlying processes that influence individual nodes of the graph G independently, and consequently does not represent any distributed behavior.

The structure of the representation 300 in FIG. 3 visually describes the intuition of the model described above. The most important and novel term in the expression above is BV. This term represents signals in Y that have the somewhat odd property that they are common across a small number of nodes, but do not influence the majority of the network. Notice that such sparse anomalies are inherently distributed phenomena. A group of sensors is only anomalous in the context of the performance of the rest of the network, and knowledge of the network at large is required to tease out the anomaly.

It can be shown that any matrix Yε [symbol] ^{m×n} can be decomposed as in the expression above in equation (1) by computing its Singular Value Decomposition (SVD), given by Y=ÛΣ\hat{V}^{T}. The desired decomposition can be produced by setting A=ÛΣ, U=\hat{V}^{T}, and B, V, N≡0. In fact, given any desired B, V, and N, such a decomposition of Y can be produced using the SVD of (Y−BV−N). Similarly, given any desired A, U, and N, such a decomposition of Y can be produced by way of the SVD of (Y−AU−N).

What is more interesting, and not possible generically, is to produce a decomposition of Y where both A is low-rank and B is sparse. Accordingly, a matrix Y may be defined herein to be patterned when it is possible to produce a decomposition of Y where both A is low-rank and B is sparse simultaneously. In other words, a definition of “pattern” is introduced based upon notions of low-rank and sparsity. Therefore, a data matrix Yε [symbol] ^{m×n} may be considered (k, s)-patterned if there exists a decomposition of Y as Y=AU+BV where A has rank k<m, B is s-sparse, and the rows of U and V are all mutually orthogonal.

The set of matrices with such a decomposition has, in the appropriate sense, zero measure. Generically, matrices are not patterned, so the detection of a patterned matrix is indicative of an unusual underlying structure. The presence of noise, however, may destroy the presence of a pattern, so the goal with noisy data is to detect when a matrix Y is close to a matrix with such a privileged patterned decomposition. In essence, according to equation (1), Yin the presence of noise should admit to the decomposition Y=AU+BV+N, where the rows of U, V, and N are all mutually orthogonal, i.e., each row represents an uncorrelated underlying process. Therefore, a data matrix Yε [symbol] ^{m×n} may be considered (k, s)-patterned with uncorrelated noise if there exists a decomposition of Y as Y=AU+BV+N where A has rank k<m, B is s-sparse, and the rows of U, V, and N are all mutually orthogonal.

It should be noted that the methods and systems introduced herein for computing this patterned decomposition may also allow for the rows of U, V, and N that are only approximately orthogonal. In some embodiments, the algorithms may allow for a user-specified slackness in a constraint.

Principal Component Analysis (PCA) is one approach for uncovering low-rank structure in matrix data. The idea is to compute the SVD and project onto only those singular vectors associated with the largest singular values. This approach provably provides the best low-rank approximation (in the sense of the Frobenius norm) to a given matrix. Unfortunately, it is well-known that PCA suffers when outliers are present. A single outlier can skew the low-rank approximated subspace arbitrarily far away from the true low-rank subspace.

Existing methods in low-rank Matrix Completion (MC) and Principal Component Pursuit (PCP) allow for careful teasing-out of sparse outliers so that the remaining low-rank approximation is faithful to the true low-rank subspace describing the raw data. Unfortunately, there are two impediments to the direct application of PCP algorithms in this context. First, while it is certainly the case that A being low rank implies that AU is low rank, there is no reason to believe that a sparse B implies that BV is sparse. Second, while PCP algorithms have been previously developed for the case of a dense N with small entries, no such assumption can be made here. It can only be assumed that the rows of N are (nearly) orthogonal, and not that the entries are necessarily small.

### Second-Order Analysis

For the reasons stated above, some embodiments analyze the second order statistics of Yε [symbol] ^{m×n} by way of its normalized correlation matrix, defined herein as M:=YY^{T}. Note that before constructing M, some embodiments preprocess the raw data in Y, so that the rows in Y are normalized with zero mean. Examining M rather than Y provides a number of key advantages. First, the problems of interest are where m<<n. In other words, the number of rows representing time traces is much less than the length of each trace. Therefore, whatever spatial information is encoded in M is done so in a highly compressed form. In particular, there are problem domains where it is feasible to communicate M, but not Y.

Second, as will be shown, M encodes a substantial amount of information about the interdependence between rows of Y. Third, studying M provides some measure of noise mitigation as compared to studying Y. For example, if N consists of uncorrelated and identically distributed draws from a zero mean, unit variance Gaussian distribution; then NN^{T} is approximately identity with off diagonal entries whose size is of the order of

$$\frac{1}{\sqrt{n}} .$$

In effect, the uncorrelated noise terms vanish in a second order analysis. Fourth, and perhaps most importantly, techniques in matrix completion allow for efficient analysis of M in the presence of realistic network topologies.

Using the latent signal model in equation (1) and the above definition of the covariance matrix, YY^{T} may be expanded to obtain:

$$M = Y {Y}^{T} = A U {U}^{T} {A}^{T} + A U {V}^{T} {B}^{T} + A U {N}^{T} + B V {U}^{T} {A}^{T} + B V {V}^{T} {B}^{T} + B V {N}^{T} + N {U}^{T} {A}^{T} + N {V}^{T} {B}^{T} + N {N}^{T} \qquad ( 2 )$$

Since, by assumption, U, V, and N are (approximately) orthogonal, cross terms may be canceled to write,

M=YY^{T}≅AΣ_{UU}A^{T}+BΣ_{VV}B^{T}+Σ_{NN} (3)

for (approximately) diagonal matrices Σ_{UU}, Σ_{VV}, and Σ_{NN}. By formally setting L:=AΣ_{UU}A^{T}, S:=BΣ_{VV}B^{T}, and E=Σ_{NN}, the notation can be made consistent with the existing PCP literature to write,

M=YY^{T}≅AΣ_{UU}A^{T}+BΣ_{VV}B^{T}+Σ_{NN}=L+S+E (4)

Generally, the observed data matrix M will have full rank m. It can be shown that any such matrix can have its rank reduced to m−k by changing k² of its entries, but the set of such full rank matrices whose rank can be reduced to m−k by changing less than k² elements has Lebesgue measure zero. It is precisely these matrices—whose rank can be considerably reduced by changing only a few entries—that may be defined as patterned according to the definition given above.

Therefore, a covariance matrix of Mε [symbol] ^{m×m} is (k, s)-patterned if there exists a decomposition of M as M=L+S where L has rank k<m, and S is s-sparse. Similarly, for the case of noisy data, a special property of a covariance matrix M may be leveraged wherein the rank of M can be reduced by k by changing less than k² of its entries, while also allowing for small changes in every entry to account for the noise. Therefore, a covariance matrix of Mε [symbol] ^{m×m} is (k, s)-patterned if there exists a decomposition of M as M=L+S+E where L has rank k<m, S is s-sparse, and E is diagonal (with perhaps small off-diagonal terms).

The small off-diagonal terms in E may arise from the fact that the underlying processes may be only approximately orthogonal. Note how the definition of the patterned second order matrix M flows from and implies the existence of a first order patterned matrix Y. The existence of low-rank L implies the existence of a low rank A, and the existence of a sparse S implies the existence of a sparse S. This solves one of the traditional problems with MC and PCP techniques described above. What remains is to describe the methods and systems for recovering the substantial amount of information encoded in Min the presence of noisy measurements.

### Matrix Decomposition

The next step in anomaly-detection analysis entails decomposing M=YY^{T} into a low-rank part that indicates the presence of a pervasive low-dimensional pattern affecting the entire network, and a sparse part that indicates sparse correlations between a few nodes that are anomalous when compared to the ambient background correlation. Consequently, in the matrix decomposition problem, a matrix M₀ that is formed by M₀=L₀+S₀ is given, where L₀ is low-rank and S₀ is sparse, and the task becomes recovering L₀ and S₀. In this section, the subscript “0” is used to denote the actual true value, such as the true L₀ and S₀, while hatted quantities such as \hat{L} and Ŝ denote quantities recovered from the given data using the algorithms discussed below. These algorithms have been shown to be faithful, meaning that, (\hat{L},Ŝ)=(L₀, S₀), or at least that the error in recovery due to noise is bounded. For example, the recovery error of ∥L₀−L₁∥+∥S₀−S₁∥≦δ for some small δ.

Given an ostensibly full-rank matrix M₀, the underlying low rank matrix L₀ must be teased out, and the sparse anomalies introduced by S₀ must be identified, without knowing a priori the true rank of L₀, and without knowing the number or locations of the nonzero entries in S₀. Furthermore, the nonzero entries in S₀ may be of arbitrarily large size. These difficulties may be further compounded by situations in which the presence of noise in the system adds small errors to each of the entries in M₀. Even more difficult situations arise when only a small subset of the entries of M₀ (perhaps only ten percent of the entries) are actually observed and recorded. This is precisely the situation that occurs when real network data is encountered and analyzed.

Analyzing M relies at least in part on matrix completion techniques that utilize various matrix norms. As used herein, ∥·∥_{*} denotes the nuclear norm, which is the sum of the singular values. If σ is the vector of singular values of matrix A, then:

$${‖ A ‖}_{*} = {\sum }_{i} {σ}_{i} \qquad ( 5 )$$

The 1-norm on matrices is denoted by ∥·∥₁: [symbol] ^{m×n}→ [symbol] , and is defined as the sum of the absolute values of the matrix entries. Note that this definition is the “entrywise 1-norm”, not the “induced 1-norm”. For matrix A with entries Aᵢⱼ, the definition is:

$${‖ A ‖}_{1} = {\sum }_{i j} \vert {A}_{i j} \vert \qquad ( 6 )$$

The 2-norm on matrices is denoted by ∥·∥₂: [symbol] ^{m×n}→ [symbol] , and is defined as the maximum singular value. Note that this definition is the “induced 2-norm”, not the “entrywise 2-norm”. For matrix A with singular values {σ₁, . . . , σₙ}, the definition is:

∥A∥=maxᵢσᵢ. (7)

The Frobenius norm on matrices is denoted by ∥·∥_{F}: [symbol] ^{m×n}→ [symbol] , and is defined as:

∥A∥_{F}=\sqrt{tr(A^{T}A)}. (8)

Also, as used herein, P_{Ω}(A) represents the projection of the matrix A onto the set of entries indexed by the indices in the set Ω. In other words,

$${ }_{Ω} {( A )}_{i j} = \{ \begin{matrix}{A}_{i j} , & i j ∈ Ω \\ 0 , & otherwise\end{matrix} . \qquad ( 9 )$$

Matrix decomposition and recovery can be guaranteed according to compressed sensing techniques. Specifically, if M₀=L₀+S₀, and we are given only a subset, Ω, of the entries of M₀, denoted P_{Ω}(M₀), then with high probability the convex program

$${min}_{L , S} {‖ L ‖}_{*} + λ {‖ S ‖}_{1} subject to { }_{Ω} ( L + S ) = { }_{Ω} ( {M}_{0} ) , \qquad ( 10 )$$

exactly recovers the low rank matrix L₀, as well as the entries of the sparse matrix S₀ that are supported on the observed set Ω. In one embodiment, λ may be fixed at (\sqrt{max(m,n)})⁻¹; however, other embodiment s may use different values depending upon the specific data set. Thus, l₁-methods allow for the decomposition of a correlation matrix into low-rank and sparse constituents even when the correlation matrix is only partially observed. The general problem of minimizing rank and sparsity subject to constraints is in fact NP-hard and consequently computationally intractable. Relaxation from rank minimization to nuclear-norm minimization and from sparsity minimization to l₁-norm minimization results in a convex optimization problem that can be efficiently solved, and that recovers the exact low-rank and sparse solution with high probability. This may be referred to as Principal Component Pursuit with Partial Observations.

With regard to matrix decomposition, the question of stability should also be addressed. Specifically, it should be determined whether the methods of PCP for performing matrix decomposition into low-rank and sparse components remain stable with the addition of small but dense noise. Because the embodiments discussed herein deal with real-world data on real networks, the measurements may contain noise in each entry. To that end, the problem may be reformulated as recovering L₀ and S₀ from M₀=L₀+S₀+Z₀ where Z₀ is a dense matrix of small noise terms. Because it can be shown that the error in the recovery of L₀ and S₀ in the presence of noise is bounded by the size of the noise, the addition of small noise does not cause catastrophic failure of the method. In the case of added noise, the convex program of interest is

$${min}_{L , S} {‖ L ‖}_{*} + λ {‖ S ‖}_{1} subject to {‖ {M}_{0} - L - S ‖}_{F} \leq δ , \qquad ( 11 )$$

and the accompanying statement of recovery guarantees with high probability that the error is bounded by an error term proportional to ∥Z₀∥_{F}. Additionally, for the case of partial observations, the associated convex program may be formulated as:

$${min}_{L , S} {‖ L ‖}_{*} + λ {‖ S ‖}_{1} subject to {‖ { }_{Ω} ( {M}_{0} ) - { }_{Ω} ( L + S ) ‖}_{F} \leq δ . \qquad ( 12 )$$

However, prior to this disclosure, there was no result that guaranteed stability in this case.

### Extending Matrix Decomposition to Pattern Detection

Embodiments herein extend the PCP technique to the cases where the magnitude of the noise is controlled entry-wise, or component-wise. Rather than considering the Frobenius norm of the error as shown above, component-wise constraints are enforced on the magnitude of the error:

$${min}_{L , S} {‖ L ‖}_{*} + λ {‖ S ‖}_{1} subject to \vert {M}_{0} - L - S \vert ≼ W , \qquad ( 13 )$$

where W is a given constraint matrix of bounds on the magnitudes of the entry-wise error. The ≦operator in equation (13) may be used to denote an entry-wise comparison in contrast to the standard≦operator. In the context of sensor networks, the introduction of this entry-wise error control is motivated by the reality that data may be received from heterogeneous sensors, and consequently, it may be beneficial to ascribe different error tolerances to each sensor. The use of component-wise constraints also ensures that large sparse entries are individually dealt with and appropriately assigned to S. Otherwise, the use of a Frobenius type error norm has the effect that a large conspicuous spike is indistinguishable from small noise distributed uniformly over the data set, since the Frobenius norm “smears” the energy from a single spike across all the entries. Hence, the use of an entry-wise constraint ensures that sparse spikes in the data are not tossed out with the low-level background noise.

This idea of entry-wise control of the error may next be extended to the case of partial observations. For this type of constraint, the convex program to be solved is:

$${min}_{L , S} {‖ L ‖}_{*} + λ {‖ S ‖}_{1} subject to \vert { }_{Ω} ( {M}_{0} ) - { }_{Ω} ( L + S ) \vert ≼ W . \qquad ( 14 )$$

Solving this problem may detect weak distributed patterns and anomalies in network data. An algorithm for efficiently solving this convex program will be presented herein below.

### A First Embodiment of a Decomposition Algorithm

Prior to this disclosure, no algorithms existed for dealing with the case of matrix decomposition with partial observations or entry-wise inequality constraints. Embodiments herein use methods to efficiently solve the cases of partial observations with noise and entry-wise inequality constraints. The method in one embodiment is based on an Augmented Lagrange Multiplier (ALM) approach that provides an iterative procedure for updating both the solution and a Lagrange multiplier. An inner loop in the iteration requires an optimization of a Lagrangian with respect to both L and S. Using the structure of the subgradients for the ∥·∥₁ and ∥·∥_{*} norms, this inner loop optimization may be performed analytically, so that the overall optimization proceeds very quickly. Using this method, decomposition of a matrix with hundreds of thousands of entries requires a few seconds to compute.

The algorithm presented here is particularly advantageous for sensor networks because it has the ability to perform optimization subject to entry-wise inequality constraints, which are indispensable when dealing with noisy data found in real-world applications. If a strictly equality-constrained algorithm were to be applied to noisy data, the resulting (L, S) decomposition would be necessarily polluted with noise. Intuitively, this is because there is nowhere else for the noise to go. In particular, the sparsity of S and the low-rank structure of L would generally be lost. Allowing for inequality constraints on each matrix entry provides sufficient slackness to de-noise the resulting \hat{L} and Ŝ, and sufficiently clean and faithful decompositions may be obtained.

The traditional algorithm for solving equality-constrained PCP is known in the art as the Robust Principal Component Analysis (RPCA). In contrast, the method for solving PCP in noisy environments using inequality constraints presented herein will be referred to as the “eRPCA”. In this acronym, the “e” in eRPCA is a reminder that inequality constraints are enforced with an entry-wise error matrix.

Before introducing the eRPCA algorithm, it may be helpful to first introduce some helpful notation. The inner-product for matrices may be defined as:

(A,B):=tr(A^{T}B) so that (A,A):=tr(A^{T}A)=∥A∥_{F}²=ΣᵢⱼAᵢⱼ². (15)

Next, the shrinkage operator S_{ε}: [symbol] → [symbol] may be defined as:

S_{ε}(x):=sign(x)max(|x|−ε,0). (16)

This may be extended to matrices by applying the matrix ε entrywise with the scalar shrinkage operator to each corresponding element. The application of S_{ε} to a matrix A shrinks the magnitude of each entry Aᵢⱼ toward zero by an amount εᵢⱼ. Similarly, the singular value shrinkage operator D_{τ} may be defined as:

D_{τ}(X):=US_{ε}(Σ)V* (17)

where UΣV* is any singular value decomposition of X. Thus, the singular value shrinkage operator D_{τ} shrinks the magnitude of a matrix along its principal directions, i.e. singular vectors.

The eRPCA method may be considered an adaptation of the ALM method. In general, the ALM method may be used to solve problems of the kind:

$${min}_{X} f ( X ) subject to h ( X ) = 0 , \qquad ( 18 )$$

where f: [symbol] ⁿ→ [symbol] is the objective function, and h: [symbol] ⁿ→ [symbol] ^{m} encodes the constraints. The formulation of the algorithm to solve this optimization begins by defining the augmented Lagrangian function as:

$$( X , Y , μ ) := f ( X ) + 〈 Y , h ( X ) 〉 + \frac{μ}{2} {‖ h ( X ) ‖}_{F}^{2} , \qquad ( 19 )$$

where μ is a positive scalar. With this Lagrangian, the ALM algorithm proceeds as follows:

(a) p≧1;

(b) while not converged, do:
(c) Solve Xₖ₊₁=argmin_{X}£(X,Yₖ,μₖ);
(d) Yₖ₊₁=Yₖ+μₖh(Xₖ₊₁);
(e)μₖ₊ᵢ=ρμₖ;

(f) end while.

The output of the ALM is generally Xₖ. During each iteration, the decision variable Xₖ and the Lagrange multipliers Yₖ and μₖ are each updated. In step (c), the Lagrangian must be minimized with respect to X. The ALM method is most effective if the minimization in step (c) is performed analytically so that the iterations can be executed very efficiently.

In one exemplary embodiment, an adaptation of the ALM method is presented for the case of performing matrix decomposition in the presence of noise. Specifically, the modified ALM may be used to solve a formulation of the ALM problem that incorporates noise as follows:

$$\begin{matrix}{min}_{L , S} {‖ L ‖}_{*} + λ {‖ S ‖}_{1} subject to \vert M - L - S \vert ≼ ε , or & ( 20 ) \\ {min}_{L , S} {‖ L ‖}_{*} + λ {‖ S ‖}_{1} subject to \vert { }_{Ω} ( M - L - S ) \vert ≼ ε . & ( 21 )\end{matrix}$$

Note that equation (20) uses a fully observed matrix M, while equation (21) uses a matrix M with partial observations using the projection operator P_{Ω}. This formulation may also be written using the shrinkage operator as follows:

$$\begin{matrix}{min}_{L , S} {‖ L ‖}_{*} + λ {‖ S ‖}_{1} subject to H := { }_{ε} ( M - L - S ) = 0. & ( 22 ) \\ {min}_{L , S} {‖ L ‖}_{*} + λ {‖ S ‖}_{1} subject to H := { }_{ε} ( {Ω}_{} ( M - L - S ) ) = 0. & ( 23 )\end{matrix}$$

Notice that the use of the shrinkage operator S_{ε} in the constraint encodes an inequality constraint on each matrix element. The shrinkage operator S_{ε} in the constraint is applied matrix-wise using the matrix of error tolerances, ε. If the shrinkage operator S_{ε} returns the zero matrix, then the inequality constraint may be considered to be satisfied.

Following this new prescription for the ALM method, the corresponding Lagrangian for this problem may be defined as:

$$( L , S , Y , μ ) := {‖ L ‖}_{*} + λ {‖ S ‖}_{1} + 〈 Y , H 〉 + \frac{μ}{2} 〈 H , H 〉 . \qquad ( 24 )$$

As required by the ALM method, the Lagrangian should be optimized with respect to both decision variables L and S. To do this, an alternating direction approach has been adopted. First, the Lagrangian may be minimized with respect to L while S is held fixed, and then the Lagrangian may be minimized with respect to S while L is held fixed. One critical ingredient in this algorithm is the ability to compute these independent optimizations analytically so that they can be evaluated quickly at each iteration. A description of each step may be carried out as described below.
Optimizing the Lagrangian with Respect to S

In order to minimize the modified Lagrangian with respect to S, one embodiment may minimize an expression that is the sum of functions that are independent in the entries of S. Generally, this expression may be of the form:

$$\frac{λ}{μ} {‖ S ‖}_{1} - t r ( \frac{{Y}^{T}}{μ} { }_{ε} ( S - ( M - L ) ) ) + \frac{1}{2} t r ( {[ { }_{ε} ( S - ( M - L ) ) ]}^{T} {ε}_{} ( S - ( M - L ) ) ) . \qquad ( 25 )$$

Because this expression is the sum of functions that are independent in the entries of S, the entire expression can be minimized by minimizing each function independently. In order to simplify the representation of this function, substitutions may be made by defining

$$α := \frac{λ}{μ} > 0 , β := - \frac{1}{μ} {Y}_{i j} , and k := {M}_{i j} - {L}_{i j} .$$

Consequently, these independent functions can be written as:

$${\sum }_{i j} [ α \vert {S}_{i j} \vert + β { }_{ε} ( {S}_{i j} - k ) + {\frac{1}{2} [ {ε}_{} ( {S}_{i j} - k ) ]}^{2} ] . \qquad ( 26 )$$

Thus, in each instance, the sum of an absolute value cone, a linear shrinkage operator, and a quadratic shrinkage operator may be minimized independently. Since the shrinkage operator and the absolute value function are piecewise defined, direct optimization of this function may require checking several cases to determine which of the piecewise defined constraints are active. In some embodiments, this involves a straight-forward exercise in case checking. For example, the algorithm may consider the relevant piecewise intervals, and compare the minimum on each interval. The elementary idea behind the method is that the shrinkage operator moves in the fastest direction for reducing the ∥·∥₁ norm, and the presence of the ε in the error constraints allows addition “wiggle” room to obtain an improved optimal value.

As stated above, a key principle is that for each choice of the summation index in equation (26), only one entry of S appears in the three terms. In other words, there are fortunately no terms in the sum that mix elements of S. For example, when the overall sum is examined in its entirety, the terms can be easily grouped so that all the terms in a group only depend on one single entry in S. Thus, there are no terms in a group that depend on more than one term in S, such as S_{4,2} cos (S_{6,5}) for example. Such a term could cause difficulty because it might not allow the groups to be formed such that they contain only one entry in S. However, because the systems and methods presented herein allow these independent groups to be formed, each group may be optimized independently with respect to the single corresponding entry in S. Notice that each grouping contains three terms (the sum of the absolute value cone, the linear shrinkage operator, and the quadratic shrinkage operator). These typically cannot be minimized independently, because they are necessarily tangled in their dependence on the single specific entry in S. Therefore, the embodiments described further below may carefully check the different intervals to find the global minimum with respect to that particular entry in S.

Optimizing the Lagrangian with Respect to L

In this step, L may be chosen such that the Lagrangian is minimized holding S fixed. The additional leeway provided by the inequality constraints allows for even further shrinking to obtain improved optimality. The “wiggle” room is used in the constraint to shrink the singular values of L even further along the maximal descent direction. It can be shown that for the case of equality constraints, the optimal value of L is given by:

$${L}_{e q} = {𝒟}_{\frac{1}{μ}} ( M - S - \frac{1}{μ} Y ) . \qquad ( 27 )$$

This expression may arise from the optimal balance of the descent directions of the nuclear norm and the constraint penalty term. When the constraints are relaxed to allow for nonzero E and inequality constraints, it may be observed that the extra freedom provided by the inequality constraint allows for further shrinking in the direction of fastest decrease of the nuclear norm. It can also be shown that an optimal L can be found by L=αL_{eq}, where 0≦α≦1 is chosen as the minimum value for which the inequality constraint is still satisfied, such as:

α=arg min_{α′}α′ such that S_{ε}(M−S−α′L_{eq})=0. (28)

Notice that α lies in the interval[0, 1]. If α is zero, then L is the zero matrix, which is the most optimal L because it has the lowest nuclear norm. On the other hand, if α is unity, then L=L_{eq}, which is evidence that some of the inequality constraints are tight, and that there is no additional room in which to improve the optimality of L subject to the tight constraints. However, α=1 is a worst-case scenario, and the solution will generally be better than this.

Embodiments utilizing the two-step optimization algorithm described above may use the eRPCA algorithm as follows:

(a) p≧1;

(b) while not converged, do:
(c1) Lₖ₊₁=find optimal L using singular value shrinkage and leeway in constraints;
(c1) Sₖ₊₁=find optimal S using matrix shrinkage and leeway in constraints;
(d) Yₖ₊₁=Yₖ+μₖHₖ₊₁;
(e)μₖ₊₁=ρμₖ;

(f) end while.

The output of the eRPCA algorithm is generally Xₖ and Lₖ. This algorithm can also be adapted to the case of partially observed data by introducing the projection operator, P_{Ω}, as appropriate to enforce agreement on only the observed entries as enumerated by Ω. Also, the iterative ALM approach is significantly faster and less memory intensive than second-order semi-definite program methods.

### A Second Embodiment of a Decomposition Algorithm

It is possible to improve upon the first embodiment of the decomposition algorithm described above. In certain circumstances, a second embodiment of the decomposition algorithm described below may be faster and substantially more accurate than the first embodiment. Certain improvements can make the second embodiment of the decomposition algorithm applicable to realistic pattern detection problems that may be beyond the reach of the first embodiment described above.

In certain circumstances, the first embodiment may suffer from slow convergence for complicated error matrices E when applied to equations (20), (21), (22), and (23). For example, if a particular problem includes a uniform random error matrix ε, then the first embodiment of the decomposition algorithm can take up to 1270 iterations of the version of the eRPCA algorithm previously described to achieve a relative error in the objective of 1.58980495474e-03.

In contrast, the second embodiment of the decomposition algorithm can perform the same computations using as few as 158 iterations of the eRPCA method to achieve a relative error in the objective of 1.06646137713e-07. In other words, the second embodiment may require only ⅛ the number of iterations to achieve a relative error in the objective which is just under 15,000 times more accurate. Accordingly, the second embodiment can be used to detect patterns that are far smaller and more subtle than those that could be detected with the first embodiment.

A key difference between the first embodiment and the second embodiment can be observed in the way that the Lagrangian is optimized with respect to L. Specifically, in the first embodiment of the decomposition algorithm, it was observed that the Lagrangian L in equation (24) can be approximately minimized with respect to L in a two-step procedure. The first embodiment minimized the equality constrained problem (where ε=0) and computed the optimal value of L as given by equation (27). Next, the value of the objective function was further reduced by finding L=αL_{eq}, where 0≦α≦1 was chosen as the minimum value for which the inequality constraint is still satisfied, as was shown in equation (28).

One feature of the first embodiment is that such an L only approximately minimizes the Lagrangian. In particular, the authors are not aware of any closed form solution for the exact minimizer of the Lagrangian with respect to L for the first embodiment. This approximation causes the issue with the convergence rate described above for the first embodiment of the decomposition algorithm. The second embodiment of the decomposition algorithm solves this problem as follows by constructing a problem for which the required minimizer can be solved for in closed form.

Recall that the first embodiment uses an adaptation of the ALM method for performing matrix decomposition in the presence of noise. Specifically, the modified ALM was used to solve a reformulation of the ALM problem that incorporated noise according to equation (22) and equation (23). These equations use the shrinkage operator S_{ε} in the constraint applied matrix-wise using the matrix of error tolerances, ε. If the shrinkage operator S_{ε} returned the zero matrix, then the inequality constraint was considered to be satisfied.

In the second embodiment of the decomposition algorithm, equation (22) and equation (23) can be rewritten as:

$$\begin{matrix}{min}_{L , S} {‖ L ‖}_{*} + λ {‖ {𝒮}_{∈} ( S ) ‖}_{1} subject to \hat{H} := M - L - S = 0. & ( 29 ) \\ {min}_{L , S} {‖ L ‖}_{*} + λ {‖ {𝒮}_{∈} ( S ) ‖}_{1} subject to \hat{H} := {𝒫}_{Ω} ( M - L - S ) = 0. & ( 30 )\end{matrix}$$

In other words, the second embodiment of the decomposition algorithm moves the shrinkage operator from the constraint to the objective. The fact that equation (22) is equivalent to equation (29) is not an obvious observation; nor is it obvious that equation (23) is equivalent to equation (30). The proof of this equivalence is beyond the scope of this disclosure, and an understanding of this proof is not necessary to implement any of the embodiments discussed herein. However, the basic idea of the proof shifts the “wiggle room” from the constraints into the objective. Note how the objectives in equation (29) and equation (30) are not affected by entries in S that are smaller than ε. Accordingly, small entries in S can be used to enforce the constraints. It is also worth noting that the expression of S_{ε} (S) in equation (29) and equation (30) is the same as the expression of S in equation (22) and equation (23).

Using the second embodiment of the decomposition algorithms, the Lagrangian to be minimized becomes:

$$ℒ ( L , S , Y , μ ) := {‖ L ‖}_{*} + λ {‖ {𝒮}_{∈} ( S ) ‖}_{1} + 〈 Y , \hat{H} 〉 + \frac{μ}{2} 〈 \hat{H} , \hat{H} 〉 . \qquad ( 31 )$$

To the authors' knowledge, the Lagrangian in equation (24) cannot be minimized with respect to L, with S fixed, in a closed form when ε≠0 for the constrained optimization problems in equation (22) and equation (23), but the Lagrangian in equation (31) can be minimized in closed form with respect to both L and S (with the other fixed) when ε≠0 for the constrained optimization problems in equation (29) and equation (30).
Optimizing the Lagrangian with Respect to S (Second Embodiment)

The minimization with respect to S for the second embodiment of the decomposition algorithm is very analogous to that of the first embodiment. In order to minimize the modified Lagrangian with respect to S, the second embodiment may minimize the expression that is the sum of functions that are independent in the entries of S. Generally, this expression may be of the form:

$$\frac{λ}{μ} {‖ {𝒮}_{∈} ( S ) ‖}_{1} - tr ( \frac{{Y}^{T}}{μ} S - ( M - L ) ) + \frac{1}{2} tr ( {[ S - ( M - L ) ]}^{T} ( S - ( M - L ) ) ) . \qquad ( 32 )$$

Because this expression is the sum of functions that are independent in the entries of S, the entire expression can be minimized by minimizing each function independently. In order to simplify the representation of this function, substitutions may be made by defining

$$α := \frac{λ}{μ} > 0 , β := - \frac{1}{μ} {Y}_{ij} , and k := {M}_{ij} - {L}_{ij} .$$

Consequently, these independent functions can be written as:

$${\sum }_{ij} [ α \vert {𝒮}_{∈} ( {S}_{ij} ) \vert + β ( {S}_{ij} - k ) + {\frac{1}{2} [ ( {S}_{ij} - k ) ]}^{2} ] . \qquad ( 33 )$$

As in the first embodiment, this sum can be partitioned into groupings where each group contains only three terms: an absolute value cone, a linear shrinkage operator, and a quadratic shrinkage operator. Each grouping depends independently on only a single entry of S (there are as many groupings as there are entries in S). Thus, the entire sum can be minimized by minimizing each grouping of three terms independently. Since the shrinkage operator and the absolute value function are piecewise defined, direct optimization of each independent grouping may require checking several cases to determine which of the piecewise defined constraints are active. The resulting operations may be carried out in a similar manner as they were in the first embodiment. To obtain the optimal value of S that minimizes the Lagrangian, each entry of S can be populated by the corresponding minimizer of each independent group.

Optimizing the Lagrangian with Respect to L (Second Embodiment)

As in the first embodiment of the decomposition algorithm, L may be chosen such that the Lagrangian is minimized while holding S fixed. As opposed to equation (27) and equation (28), the new formulation of the second embodiment of the decomposition algorithm in equation (29) and equation (30) can have an exact optimal value of L as given by:

$$L = {𝒟}_{\frac{1}{μ}} ( M - S - \frac{1}{μ} Y ) . \qquad ( 34 )$$

One key difference is that the derivative of the Lagrangian in equation (31) with respect to L does not depend on S_{ε} (S).

The second embodiment with the two-step optimization algorithm described above may use a modified version of the eRPCA algorithm as follows:

(a) p≧1;

(b) while not converged, do:
(c1) Lₖ₊₁=find optimal L using singular value shrinkage
(c1) Sₖ₊₁=find optimal S using matrix shrinkage and leeway in constraints;
(d) Yₖ₊₁=Yₖ+μₖHₖ₊₁;
(e)μ_{μ+1}=ρμₖ;

(f) end while.

The output of this algorithm is generally S_{ε} (Sₖ) and Lₖ. As was the case in the first embodiment of the decomposition algorithm, this algorithm can also be adapted to the case of partially observed data by introducing the projection operator, P_{Ω}, as appropriate to enforce agreement on only the observed entries as enumerated by Ω.

Implementing the eRPCA

Next, a specific embodiment of the eRPCA method described above is presented. Although specific values are given for one or more of the variables, it will be understood in light of this disclosure that these are merely exemplary, and may be altered according to each specific application. Similarly, the steps described below may be altered within the spirit of the general framework of the methods described above. Therefore, this embodiment is merely exemplary, and not meant to be limiting.

In this embodiment, the following constants in the problem data may be given:

The raw data matrix: Mε [symbol] ^{m×n}.

The matrix of point-wise error bounds: εε [symbol] ^{m×n}.

The scalar weighting factor: λε [symbol] (which is often

$$\frac{1}{\sqrt{max ( m , n )}} ) .$$

The set of observed indices, Ω.

In addition, a tolerance parameter, tol, that specifies the maximum allowed error in the solution may be provided. A smaller tolerance may require a larger number of iterations inside the algorithm to obtain convergence.

This specific embodiment may use the following internal variables: Yε [symbol] ^{m×n}, Lε [symbol] ^{m×n}, Sε [symbol] ^{m×n}, με [symbol] , ρε [symbol] , and converged ε{True,False}. These values may be initialized as follows:

$$Y = \frac{M}{{‖ M ‖}_{2}}$$

in one embodiment; Y=0 in another embodiment

L=0

S=0

μ=0.8∥M∥₂ in one embodiment; μ=1.25/∥M∥₂ in another embodiment

ρ=1.5 in one embodiment; ρ=1.1 in another embodiment

converged=False

Using these values, the first embodiment of the decomposition algorithm may begin to iterate towards converging values. The “while” loop in the eRPCA method may be implemented with the following steps:

1. Record the current values of L and S:
\hat{L}=L;
Ŝ=S;

2. Update the values of L and S:
L=D_{μ-1}(M−S+μ⁻¹Y);
S=Find_Optimal_S(M, L, ε, Y, μ);

3. Update the Lagrange multipliers
Y=Y+μS_{ε}(M−L−S);
μ=min(ρμ, 1.0);

4. Check for convergence
Δ∥L−\hat{L}∥₂+∥S−Ŝ∥₂;
If (Δ<tol) then (converged=True);

When using the second embodiment of the decomposition algorithm the “while” loop in the eRPCA method may be implemented with fewer steps, as follows:

1. Update the values of L and S:
L=D_{μ-1}(M−S+μ⁻¹Y);
S=Find_Optimal_S (M, L, ε, Y, μ);

2. Update the Lagrange multipliers
Y=Y+μ(M−L−S);

3. Check for convergence
Δ=∥M−L−S∥_{F}/∥M∥_{F};
If (Δ<tol) then (converged=True);

All that remains is to provide the description of the function Find_Optimal_S(M, L, ε, Y, μ). The purpose of this function is to find the value of S that minimizes the Lagrangian. Recall from equation (24) that the Lagrangian comprises a function of the form F: [symbol] ^{m×n}→ [symbol] . Also recall that this is a scalar function of the entries in S, as is illustrated by equation (25). Thus, for each entry, the sum of an absolute value cone, a linear shrinkage operator, and a quadratic shrinkage operator may be minimized. Each grouping of terms in this sum can be minimized independently to obtain the global minimum where each group depends only on a single entry in S. To minimize each grouping of terms efficiently, this embodiment may consider the relevant piece-wise intervals, and compare the minimum on each interval. Once each entry in Sᵢⱼ is obtained independently, then the optimal S may be determined from these independently obtained optimal entries.

As an example, consider the case of minimizing the terms for the ij entry in S using the term-wise portion of equation (26),

$$α \vert {S}_{ij} \vert + {β𝒮}_{∈} ( {S}_{ij} - k ) + {\frac{1}{2} [ {𝒮}_{∈} ( {S}_{ij} - k ) ]}^{2} . \qquad ( 29 )$$

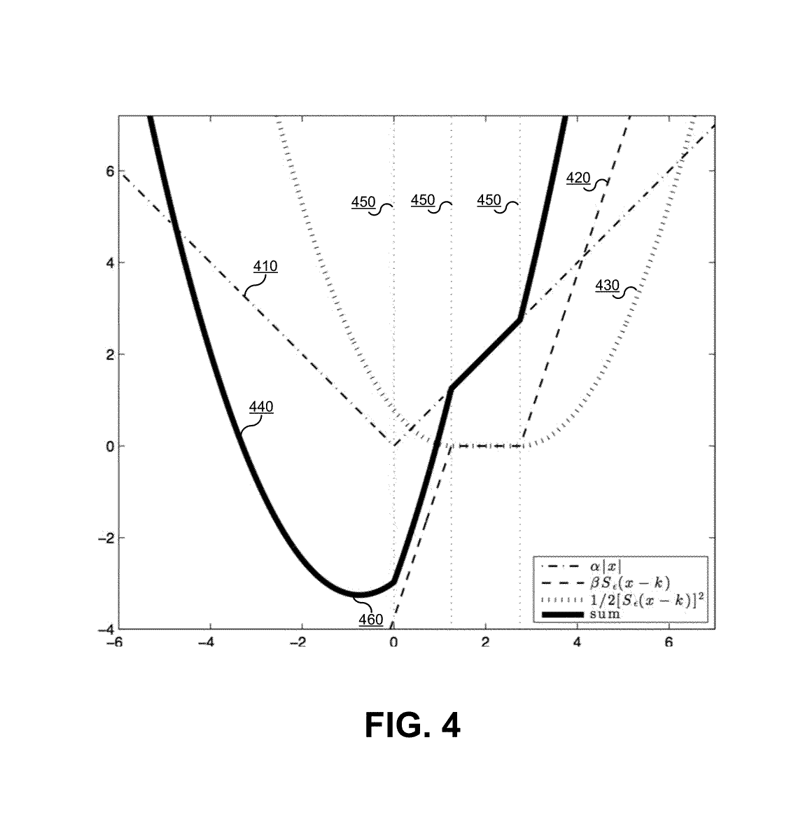

FIG. 4 illustrates an example of minimizing the Lagrangian using specific values. The graph shows the absolute value term 410, the linear shrinkage term 420, and the quadratic shrinkage term 430. When added together, their sum 440 is also shown. The vertical lines 450 indicate the intervals on which the sum is piecewise defined. The global minimum is obtained by computing the minimum on each of these intervals, and then comparing to obtain the global minimum. The interval on which the minimum occurs changes depending on the relative values of α, β, k, and εᵢⱼ. For this particular example, the minimum 460 is found at

$${S}_{ij} = - \frac{3}{4} .$$

### Detecting Anomalies

Given a data matrix M, the eRPCA methods described above may return matrices L and S. Now, it is possible to determine whether these matrices indicate the presence of an anomaly. The presence of anomalies may be associated with a low-rank L, and a sparse S.

First, it may be determined whether L is sufficiently low-rank. The rank of a matrix may be given by the number of nonzero singular values. However, it is well-known that due to computational round-off errors, the list of computed singular values of an n×n matrix of rank r will not contain n−r zero values. Instead, we expect such a matrix to have r large singular values and n−r small singular values. To determine the rank of L, a threshold, ranktol>0, may be specified. This is usually a small number. For example, a number such as 1.0e⁻⁶ may be a typical value for floating-point precision. Next, the singular value decomposition of L may be computed to obtain the set of singular values {σ₁, . . . , σₙ}, and determine the number of singular values greater than ranktol:

rank(L):=|{σ:σε{σ₁, . . . ,σₙ},σ>ranktol}|. (30)

The matrix Lε [symbol] ^{m×n} may be determined to be low rank if,

$$rank ( L ) < \frac{1}{2} min ( m , n ) . \qquad ( 31 )$$

Next, it may be determined whether S is sufficiently sparse. The sparsity of S may be given by the number of nonzero entries in S. Again, due to computational round off, it is not expected that many of the entries of S will be identically zero. Instead, a threshold, sparsitytol>0, may be specified. Again, this threshold may be a small number (1.0e⁻⁶, for example) to allow for finite computational precision. Then, sparsity may be defined as,

sparsity(S):=|{s: s is an entry of S,s>sparsitytol}|. (32)

The matrix Sε [symbol] ^{m×n} may be determined to be sufficiently sparse if,

$$sparsity ( S ) < \frac{1}{2} mn . \qquad ( 33 )$$

Note that these thresholds for determining whether matrices are low-rank and sparse are merely exemplary. Other embodiments may use different thresholds and methods in accordance with each specific application.

Finally, L and S may be used to identify anomalies. If, for a given set of data M, a low-rank L and a sparse S are recovered, then it may be determined that an anomaly has been identified. In order to identify the location of the anomaly, the largest values in S may be located. For a large entry Sᵢⱼ in S, it may be surmised that an anomalous correlation has occurred between nodes i and j. In practice, a threshold, anomalytol, may be specified. The set of anomalies may then be associated with all the entries of S that are larger than anomalytol. However, other means of locating anomalies may also be used.

### Example Application

The example application in this section provides validation of this approach to pattern detection for real sensor networks by using Abilene Internet 2 data. This example first provides some basic algorithmic tests by injecting known patterns into the Abilene data. Next the embodiments disclosed above are used to analyze the raw Abilene data to identify anomalous patterns.

The first test conducted was a “null-hypothesis” test for blank data. In particular, an important question is whether the recovery of a low-rank matrix L and sparse matrix S following an L+S decomposition using the eRPCA algorithm is truly due to a structure in the signal matrix Y as was hypothesized above, or whether the low-rank and sparse decomposition is easily and spuriously obtained for purely random data that contains no structure. In particular, there is the parameter λ in equation (14) whose optimal value is given on theoretical grounds. Beyond the regimes where the theory guarantees recovery, these tests were used to analyze the failure modes of the algorithms as a function of λ. Accordingly, many Monte-Carlo studies with Gaussian random matrices were performed to assess the performance of the algorithms. The effectiveness of the decomposition was evaluated by comparing the degrees of freedom in the recovered L and S matrices with the degrees of freedom in the given matrix M.

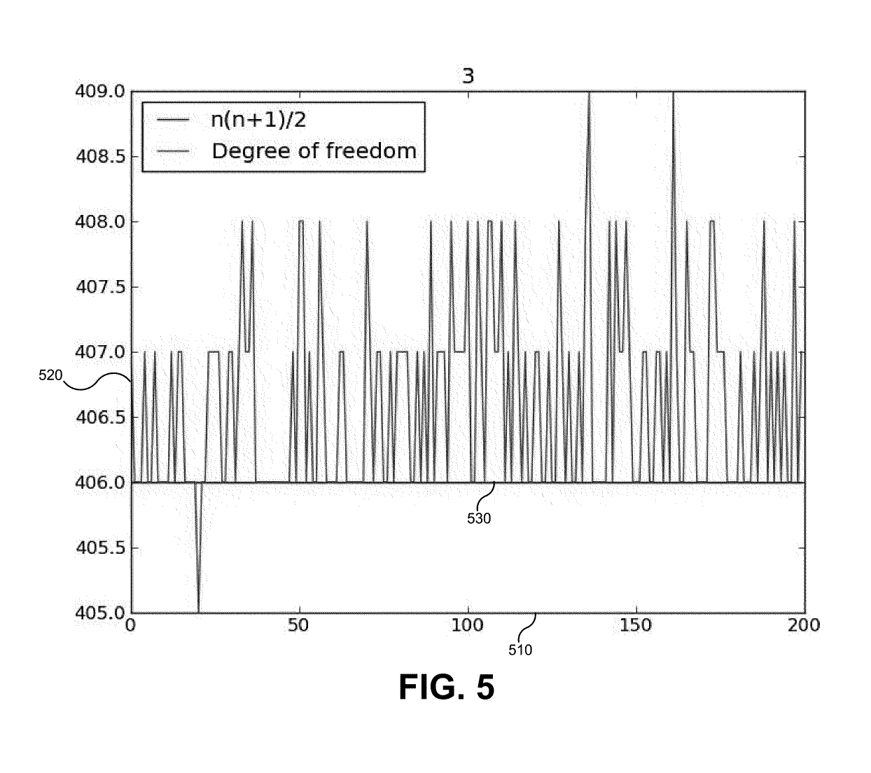

The simulation results indicated, as expected, that a patterned L+S decomposition almost never occurs spontaneously in random data, and the frequency of its occurrence is a function of the chosen error tolerances. These findings provide assurance that the algorithms will not deceptively claim detection of patterns when no such patterns or structures exist. FIG. 5 illustrates the results of a series of Monte Carlo tests using random M matrices. The x-axis 510 represents the number of matrices tested, and the y-axis 520 represents the number of degrees of freedom measured. As evidenced by the results, the returned number of degrees of freedom in a random matrix is nearly always bounded from below by the expected number of degrees of freedom represented by line 530.

The limits of these methods were also tested by increasing the sparsity of S, the rank of L, the size of the noise, and the number of missing entries. As expected, the algorithm fails as any combination of these parameters is increased too far. The nature of the theorems that guarantee exact recovery are such that they provide bounds in order to establish the claims, but do not necessarily provide sharp bounds that clearly define the regions of validity. When matrix decomposition techniques are applied to real data, they are almost certainly operating in parameter regions outside those specified by the theorems; however, experience shows that these methods continue to produce valid results in regimes far outside those governed by the theorem statements. In other words, the theorem statements may be overly pessimistic with respect to recovery.

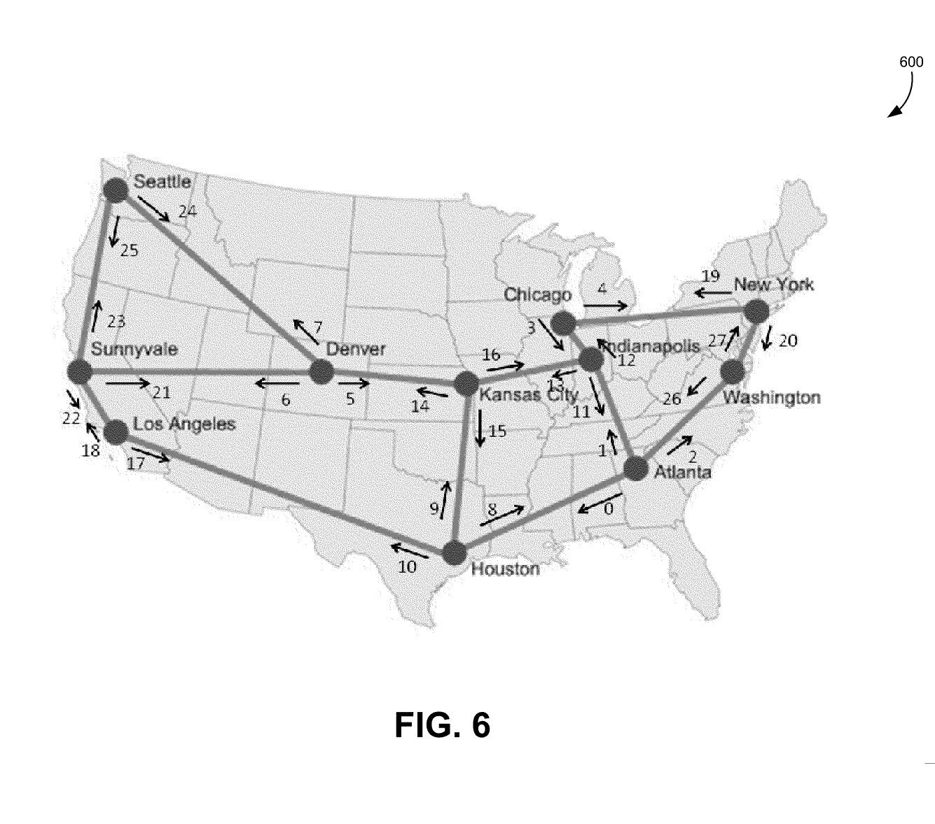

Following the theoretical and Monte Carlo testing, the methods and systems described herein were applied to recorded time traces from the Abilene Internet 2 network backbone. Working with this data focused on the search for anomalies in large volumes of data. Specifically, the Abilene data provided a year's worth of data containing probes of packet throughput over 5 minute intervals for 28 links, thus providing an extensive data set with Yε [symbol] ^{28×10800}. FIG. 6 illustrates a map 600 showing the geographical location of the nodes that participated in the Abilene network. The Abilene data is not labeled with any anomalies. Accordingly, there is no “truth” with which to compare the veracity of the results provided by the present invention. Fortunately, the methods and systems disclosed herein do not need to perform pattern matching to a predefined library of known pattern templates. Accordingly, the lack of such a library or labeled training data does not hinder this analysis.

In order to ensure that a detected pattern was not simply a fluctuation that would occur even in purely random data, a two-pronged approach was taken. First, the Abilene data was used as a real background into which a synthetic pattern was injected. The goal was to determine if a designed pattern could be detected after it was hidden by the ebb and flow of data in the real network. Second, a pattern was detected using only a second-order analysis of the Abilene data, and then cross-validated by an a posteriori examination of the first-order data. Interestingly, this subsequent first-order analysis based on the second order analysis may be how some embodiments may be used most effectively. In other words, the second-order analysis may be viewed as a pre-processing step that automatically detects patterns in voluminous real world data, and then presents to the user a condensed view of the network performance and anomalies that highlights areas requiring further analysis.

Testing began on the Abilene dataset by injecting a manufactured, known pattern into the native data stream. The original Abilene data was denoted by Oε [symbol] ^{28×8500}, and the Abilene data containing the injected pattern was denoted by Pε [symbol] ^{28×8500}. The injected pattern only affected a few nodes over a very brief time interval. The small set of affected nodes was denoted by D, and the indices of the discrete time interval over which the pattern was injected was denoted by [s₀, s₁]. Then, the entries of the anomalous time trace (a row vector representing the injected pattern) Sε [symbol] ^{28×8500}, may be defined by:

$${S}_{j} := \{ \begin{matrix}i . i . d . draw from N ( 0 , σ ) , & {s}_{0} \leq j \leq {s}_{1} \\ 0 , & otherwise\end{matrix} \qquad ( 34 )$$

for some σ specifying the nominal size of the injected pattern.

This anomalous time trace S was injected into the original Abilene data O to produce the patterned data P as follows:

$${P}_{ij} := \{ \begin{matrix}{O}_{ij} + {S}_{j} , & i ∈ D \\ {O}_{ij} , & otherwise\end{matrix} \qquad ( 35 )$$

In this way, the anomalous time trace was injected into the few nodes in set D during the time interval [s₀,s₁]. The results of the pattern detection methods were compared to the original data O and the artificially infected data P.

A subset of the columns of O starting at column n₀ and ending with column n₁ was denoted by O[n₀,n₁]. The pattern detection methods were then tested by choosing some starting point n₀ and interval size r and using the methods on subsequences of data. Accordingly, O[n₀,n₀+r] was compared to P[n₀,n₀+r].

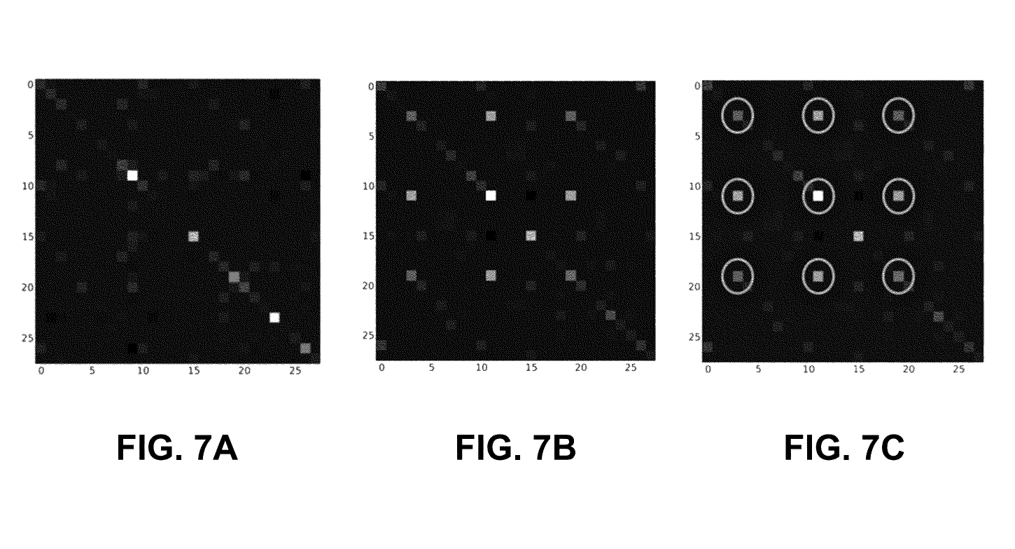

It should be emphasized that even though only three of the 28 time series in O were perturbed, the cross correlation matrix M_{OO}≈OO^{T} was extensively changed. By only examining M_{OO}, it was not readily apparent which time series has been perturbed. On the other hand, examination of the L+S decomposition computed by way of the eRPCA method was much more revealing. FIG. 7A illustrates an example of the sparse S matrix from a time period before the pattern was injected. Note that there are strong diagonal entries, indicating nodes whose measurements have a component which is uncorrelated with the rest of the nodes, but no off-diagonal entries indicative of sparse patterns. FIG. 7B illustrates an example of the sparse S from a time period during the injected pattern. It shows precisely the strong off-diagonal entries predicted by the theories discussed herein. FIG. 7C illustrates a cross validation in which those entries that should be active based upon foreknowledge of the injected pattern are highlighted to show that they exactly coincide. These tests revealed not only the existence of an anomalous pattern, but also indicated which time series were affected. Equation (4) implies that correlations observed at a sparse set of nodes should appear as strong off-diagonal entries in S=BΣ_{VV}B^{T}, and FIG. 7 displays precisely this phenomenon.

To summarize the second set of tests, a weak distributed pattern was injected into real data. The pattern could not possibly have been detected at any single node since it is only the correlation of the pattern between a set of nodes that is anomalous. Using the eRPCA method described above, the low-dimensional background correlations were extracted and the sparse anomalous pattern was detected. Only second order information was used—a much smaller matrix than the raw first order data—to detect which sparse set of spatially distributed nodes possessed the correlated signal.

Next it was determined whether a similar study could be performed on the original Abilene data without artificially injecting a pattern. This extended the results of the previous test in two important ways. First, the raw Abilene data was examined without injecting any designed pattern. The idea was to see if the methods and systems disclosed herein could detect a pattern without any type of a priori pattern template. Second, the real Abilene network topology was used to construct a projection operator P as in equation (9). Up to this point, only fully-observed correlation matrices M were studied. However, the methods and systems disclosed herein allow M to be decomposed into L+S even when only a small fraction of the entries of M are actually known. This idea is quite powerful in that it allows L+S to be computed using only those parts of M that can be computed locally.

Recall that the entries of M are the inner products of each pairing of time series produced at all the nodes. Accordingly, to fully observe M one must perform an inner product on every pair of rows in Y even if the nodes are widely separated in the network. On the other hand, a partially observed M can be produced using only time series that exist at neighboring nodes in the graph G. For the Abilene data, even a better result was obtained. The time series in this example happened to correspond to packet rates across bi-directional Internet links. Therefore, each node possessed the time series for every link that either originated or terminated at that node. Accordingly, a partially observed M could be computed without the transmission of any time series. Each node used only the transmitted or received time series it already had on hand based upon its normal operating procedure. Note, the results of the distributed inner products still needed to be collected at some central node for processing, but because m<<n and because the inner product is a single scalar, the size of this dataset was minuscule when compared to the original time series.

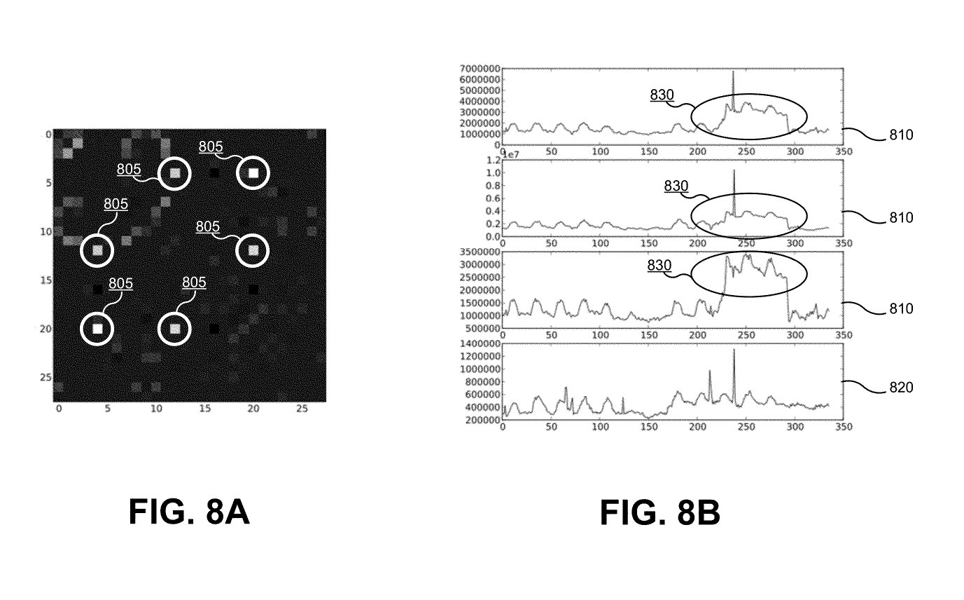

Using this testing procedure, patterns appeared naturally in several places in the raw Abilene data. FIG. 8A illustrates an example of a pattern detected from the raw Abilene data. A sparse S matrix computed by way of the eRPCA algorithm with strong off-diagonal entries 805 indicated the presence of a sparse pattern that only affected a small portion of the nodes in the network. FIG. 8B illustrates the three corresponding time series 810 on top that illustrate the detected anomaly. A fourth uncorrelated time series 820 is also included on the bottom for reference. The pattern that was detected was the three-day traffic anomaly 830 highlighted by the ovals. Neither the form of the pattern (a three-day traffic anomaly) nor the actual time series were needed for the analysis. Note that the three anomalous links were not randomly distributed in the network.

Of particular importance, the methods and systems disclosed herein detected a traffic anomaly that affected three Abilene links over the course of a three-day period without any predefined pattern template. When these calculations were performed, it was not even imagined that such traffic anomalies existed. Regardless, this pattern was detected using only second order information. Also, every inner product that was used was available at some sensor on the network without requiring the communication of any additional time series information. Thus, a weak distributed pattern in a sensor network was detected with no foreknowledge of the type of the pattern. In addition, only a highly compressed form of the data natively available on the network was required. Therefore, these methods were extremely efficient in their use of network resources.

In these tests, it was shown how latent patterns and anomalies may be revealed in the structure of L and S. Since some embodiments purposefully do not assign value judgments or semantic rules to these patterns, the patterns may or may not indicate cyber-attacks. Nevertheless, by efficiently processing large amounts of data from across the network, this approach is able to identify unusual distributed behaviors that deserve further attention. In this way, the limited resources of a network administrator may become focused by pinpointing exactly where the administrator should look to identify intrusion and attack.

In other embodiments, the methods and systems described herein may be augmented to make a value judgment as to the nature of the anomaly. Making the link between anomalous behavior and attacks enables detailed evaluation of the results using data corresponding to known prior attacks. Data patterns from actual attacks processed using this approach could yield new insights, classifications, and techniques that help identify and counter these attacks. Furthermore, irrespective of intent, detection of traffic anomalies is important for managing the network and allocating resources dynamically to handle any abnormalities. In the simplest of cases, abnormal or heavy activity on multiple links may be an indication of congestion onset or hardware malfunction, and its detection may facilitate a rapid and focused response.

### Hardware

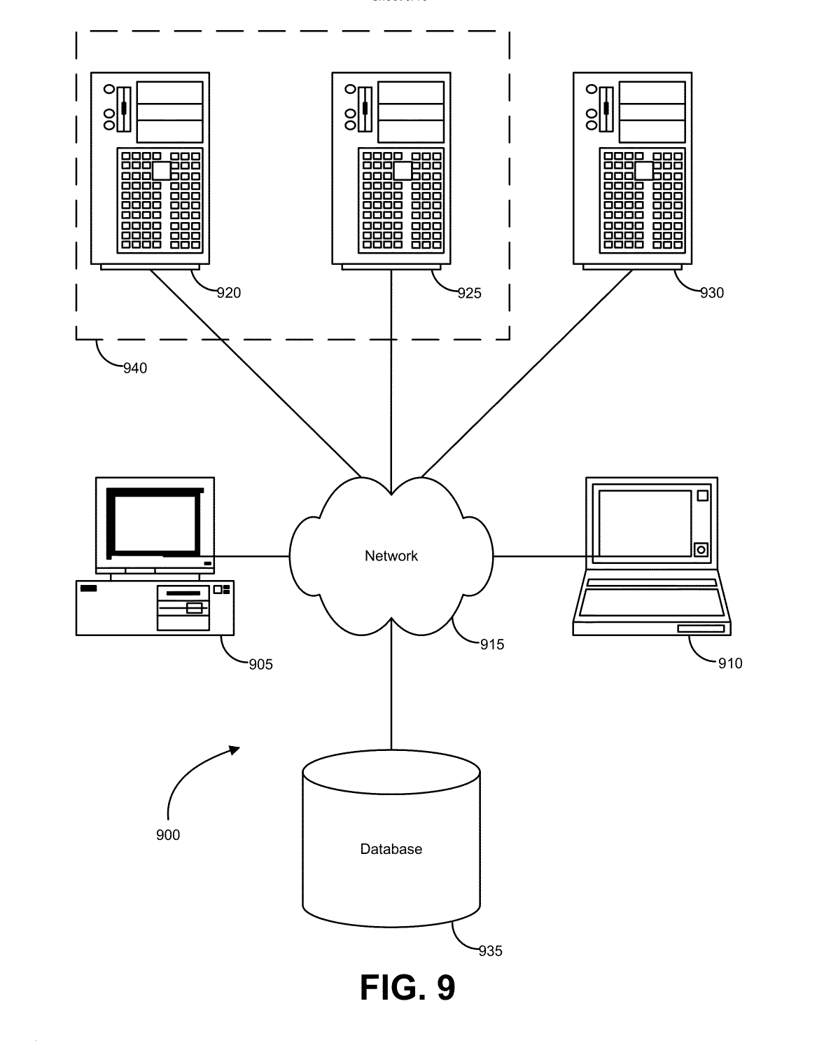

Each of the embodiments disclosed herein may be implemented in a computer system. FIG. 9 is a block diagram illustrating components of an exemplary operating environment in which various embodiments of the present invention may be implemented. The system 900 can include one or more user computers 905, 910, which may be used to operate a client, whether a dedicated application, web browser, etc. The user computers 905, 910 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 905, 910 may also have any of a variety of applications, including one or more development systems, database client and/or server applications, and web browser applications. Alternatively, the user computers 905, 910 may be any other electronic device, such as a thin-client computer, Internet-enabled mobile telephone, and/or personal digital assistant, capable of communicating via a network (e.g., the network 915 described below) and/or displaying and navigating web pages or other types of electronic documents. Although the exemplary system 900 is shown with two user computers, any number of user computers may be supported.

In some embodiments, the system 900 may also include a network 915. The network may can be any type of network familiar to those skilled in the art that can support data communications using any of a variety of commercially-available protocols, including without limitation TCP/IP, SNA, IPX, AppleTalk, and the like. Merely by way of example, the network 915 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 920, 925, 930 which can be general purpose computers and/or specialized server computers (including, merely by way of example, PC servers, UNIX servers, mid-range servers, mainframe computers rack-mounted servers, etc.). One or more of the servers (e.g., 930) may be dedicated to running applications, such as a business application, a web server, application server, etc. Such servers may be used to process requests from user computers 905, 910. The applications can also include any number of applications for controlling access to resources of the servers 920, 925, 930.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 905, 910. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 905, 910.

In some embodiments, an application server may create web pages dynamically for displaying on an end-user (client) system. The web pages created by the web application server may be forwarded to a user computer 905 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 900 may also include one or more databases 935. The database(s) 935 may reside in a variety of locations. By way of example, a database 935 may reside on a storage medium local to (and/or resident in) one or more of the computers 905, 910, 915, 925, 930. Alternatively, it may be remote from any or all of the computers 905, 910, 915, 925, 930, and/or in communication (e.g., via the network 920) with one or more of these. In a particular set of embodiments, the database 935 may reside in a storage-area network (“SAN”) familiar to those skilled in the art. Similarly, any necessary files for performing the functions attributed to the computers 905, 910, 915, 925, 930 may be stored locally on the respective computer and/or remotely, as appropriate. In one set of embodiments, the database 935 may be a relational database, such as Oracle 10g, that is adapted to store, update, and retrieve data in response to SQL-formatted commands.

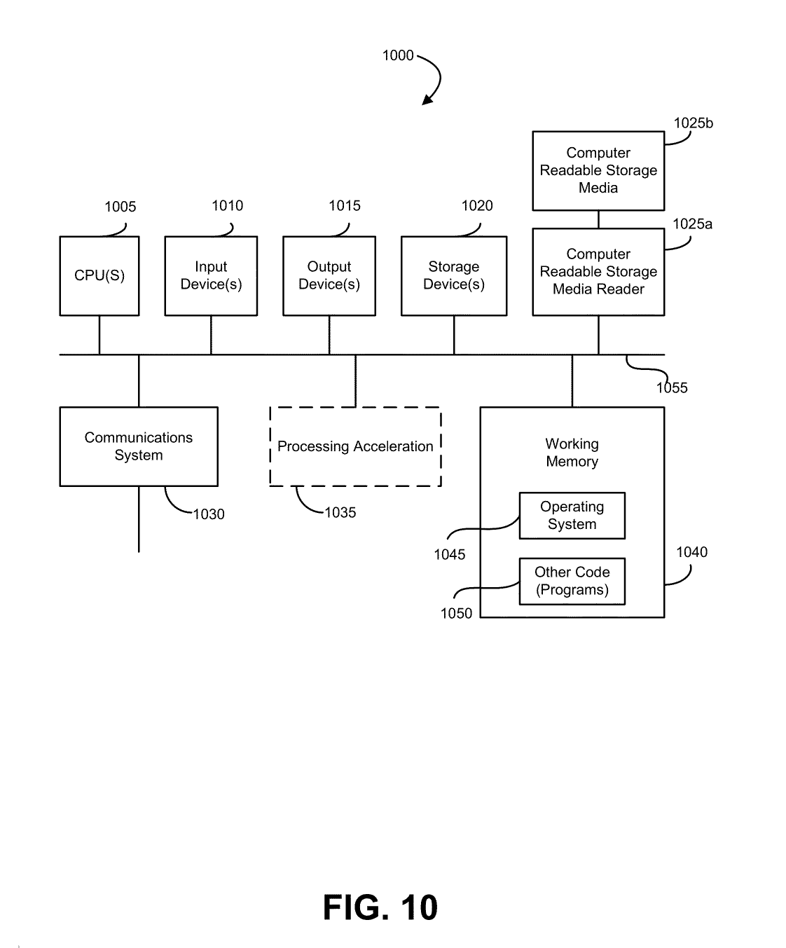

FIG. 10 illustrates an exemplary computer system 1000, in which various embodiments of the present invention may be implemented. The system 1000 may be used to implement any of the computer systems described above. The computer system 1000 is shown comprising hardware elements that may be electrically coupled via a bus 1055. The hardware elements may include one or more central processing units (CPUs) 1005, one or more input devices 1010 (e.g., a mouse, a keyboard, etc.), and one or more output devices 1015 (e.g., a display device, a printer, etc.). The computer system 1000 may also include one or more storage device 1020. By way of example, storage device(s) 1020 may be disk drives, optical storage devices, solid-state storage device such as a random access memory (“RAM”) and/or a read-only memory (“ROM”), which can be programmable, flash-updateable and/or the like.

The computer system 1000 may additionally include a computer-readable storage media reader 1025a, a communications system 1030 (e.g., a modem, a network card (wireless or wired), an infra-red communication device, etc.), and working memory 1040, which may include RAM and ROM devices as described above. In some embodiments, the computer system 1000 may also include a processing acceleration unit 1035, which can include a DSP, a special-purpose processor and/or the like.

The computer-readable storage media reader 1025a can further be connected to a computer-readable storage medium 1025b, together (and, optionally, in combination with storage device(s) 1020) comprehensively representing remote, local, fixed, and/or removable storage devices plus storage media for temporarily and/or more permanently containing computer-readable information. The communications system 1030 may permit data to be exchanged with the network 1020 and/or any other computer described above with respect to the system 1000.

The computer system 1000 may also comprise software elements, shown as being currently located within a working memory 1040, including an operating system 1045 and/or other code 1050, such as an application program (which may be a client application, web browser, mid-tier application, RDBMS, etc.). It should be appreciated that alternate embodiments of a computer system 1000 may have numerous variations from that described above. For example, customized hardware might also be used and/or particular elements might be implemented in hardware, software (including portable software, such as applets), or both. Further, connection to other computing devices such as network input/output devices may be employed. Software of computer system 1000 may include code 1050 for implementing embodiments of the present invention as described herein.

Each step of the methods disclosed herein may be done automatically by the computer system, and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a Web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Therefore, it will be understood in light of this disclosure, that each step and each method described herein may be altered to include an input and output to and from a user, or may be done automatically by a computer system.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of detecting an anomaly in a sensor network for diagnosing a network attack, the method comprising:
receiving, using a computer system, a data set comprising a plurality of vector-valued measurements from a plurality of sensors;
decomposing the data set into a low-rank component L and a sparse component S using an Augmented Lagrange Multiplier (ALM) method, wherein:
at least one of L or S are determined using an exact minimizer of a Lagrangian in the ALM method;
L represents patterns that occur in a relatively large number of the plurality of sensors; and
S represents patterns that occur in a relatively small number of the plurality of sensors; and
ascertaining, using the computer system, the anomaly in the data set based on the patterns in the sparse component S.

2. The method of claim 1 further comprising receiving a constraint matrix E comprised of error tolerances for the plurality of vector-valued measurements from the plurality of sensors, wherein:
L is determined using singular value shrinkage; and
S is determined using matrix shrinkage and leeway in the constraint matrix E.

3. The method of claim 1 further comprising transforming the data set into its normalized correlation matrix defined by the product of the data set and a transpose of the data set, wherein the transformation is done prior to decomposing the data set.

4. The system of claim 3, wherein the normalized correlation matrix of the data set comprises a correlation between a subset of plurality of vector-valued measurements based on physical communication pathways between the plurality of sensors.

5. The method of claim 3 further comprising:
determining the anomaly in the normalized correlation matrix based on the patterns in the sparse component S; and
determining whether the anomaly represents unrecognized activity by analyzing the data set using at least the anomaly in the normalized correlation matrix.

6. The system of claim 3 further comprising:
determining a location of the anomaly in the data set; and
determining whether the anomaly represents malicious intent by analyzing the normalized correlation matrix using the location of the anomaly in the data set.

7. The method of claim 1 further comprising determining that S is sparse if the number of entries in S that are less than a predetermined tolerance is less than a threshold proportional to the number of the plurality of sensors multiplied by the number of vector-valued measurements.

8. The method of claim 1 further comprising determining that L is low rank if the number of singular values of L that are less than a predetermined tolerance is less than a threshold proportional to the number of the plurality of sensors.

9. The method of claim 1 wherein one or more of the plurality of sensors are heterogeneous, such that the error tolerance assigned to each of the plurality of sensors is not uniform.

10. The method of claim 1 wherein the data set is represented in a memory as a matrix constructed by concatenating the plurality of vector-valued measurements, wherein each line in the matrix represents the plurality of vector-valued measurements from one of the plurality of sensors.

11. The method of claim 1 further comprising decomposing the data set into a third component E that is approximately diagonal representing phenomena uncorrelated with any other sensors.

12. The method of claim 11 wherein the phenomena uncorrelated with any other sensors represents uncorrelated noise.

13. The method of claim 1 wherein decomposing the data set comprises minimizing ∥L∥_{*}+λ∥S_{ε}(S)∥₁ with respect to L and S subject to a constraint that PΩ(M−L−S)=0 wherein:
P comprises a projection operator;
M comprises a subset of the pair-wise similarities of the plurality of sensors;
Ω comprises designations of the entries in M that are used;
λ comprises a scalar weighting factor;
S comprises a shrinkage operator.

14. The computer-readable memory of claim 1, wherein each iteration of the ALM updates the value of L according to the exact minimizer L=D_{μ-1}(M−S+μ⁻¹Y), wherein:
M comprises a subset of the pair-wise similarities of the plurality of sensors;
με [symbol] , and μ is proportional to ∥M∥₂;
Y comprises a value proportional to
$$\frac{M}{{‖ M ‖}_{2}} ;$$
and
D comprises a singular value shrinkage operator.

15. The computer-readable memory of claim 1, wherein each iteration of the ALM updates the value of S by determining a minimum value of a sum of:
an absolute value cone,
a linear shrinkage operator, and
a quadratic shrinkage operator.

16. The computer-readable memory of claim 15, wherein the sum is further divided into one or more groupings of terms, each of the one or more groupings of terms depending on only a single value in S, and each of the one or more groupings of terms being minimized independently.

17. A system comprising:
one or more processors; and
a memory communicatively coupled with and readable by the one or more processors and having stored therein a sequence of instructions which, when executed by the one or more processors, cause the one or more processors to detect an anomaly in sensor data by:
receiving a data set comprising a plurality of vector-valued measurements from a plurality of sensors;
receiving a constraint matrix E comprised of error tolerances for the plurality of vector-valued measurements from the plurality of sensors;
decomposing the data set into a low-rank component L and a sparse component S using an Augmented Lagrange Multiplier (ALM) method, wherein:
L is determined using an exact minimizer of a Lagrangian in the ALM method;
L represents patterns that occur in a relatively large number of the plurality of sensors; and
S represents patterns that occur in a relatively small number of the plurality of sensors; and
ascertaining the anomaly in the data set based on the patterns in the sparse component S.

18. A computer-readable memory having stored thereon a sequence of instructions which, when executed by one or more processors, causes the one or more processors to detect an anomaly in sensor data by:
receiving a data set comprising a plurality of vector-valued measurements from a plurality of sensors;
receiving a constraint matrix E comprised of error tolerances for the plurality of vector-valued measurements from the plurality of sensors;
decomposing the data set into a low-rank component L and a sparse component S using an Augmented Lagrange Multiplier (ALM) method, wherein:
L is determined using an exact minimizer of a Lagrangian in the ALM method;
L represents patterns that occur in a relatively large number of the plurality of sensors; and
S represents patterns that occur in a relatively small number of the plurality of sensors; and
ascertaining the anomaly in the data set based on the patterns in the sparse component S.
